(19) United States
(12) Patent Application Publication
(10) Pub. No.: US 2022/0222760 A1
(43) Pub. Date: Jul. 14, 2022

(54) Asset Verification Systems and/or Methods

(71) Applicant: Ai Motor Pty Ltd, Melbourne (AU)

(72) Inventors: Francesco Losinno, Aspendale (AU); Davide Mazzeo, Port Melbourne (AU)

(21) Appl. No.: 17/614,488

(22) PCT Filed: Jul. 17, 2020
(86) PCT No.: PCT/AU2020/050744

§ 371 Date: Nov. 26, 2021

(30) Foreign Application Priority Data
Jul. 17, 2019 (AU) 2019902532

(51) Int. Cl. G06Q 50/18; G06Q 20/12

(52) U.S. Cl. CPC G06Q 50/184; G06Q 20/1235

(57) ABSTRACT

A method for acquiring, aggregating and analysing asset data from multiple data sources for asset identification, verification and/or information display purposes, including: acquiring initial asset data for a selected asset from a first data source, the initial asset data including at least one identifier for the asset, and/or an word(s)/image(s) of the asset; utilising the initial asset data and/or the identifier, to retrieve further asset data associated with the asset from two or more further data sources; aggregating and analysing the acquired/retrieved initial and further asset data; and, utilising artificial intelligence or machine learning to vet the acquired/retrieved asset data in order to verify particulars of the asset; wherein the vetted asset data can be used for identification, verification and/or information display purposes related to the asset.

### CROSS-REFERENCE

This application claims the benefit of Australian Provisional Patent Application No.: 2019902532, filed on 17 Jul. 2019, the entire contents of which is incorporated herein by reference thereto.

### TECHNICAL FIELD

The present invention relates generally to asset verification systems and/or methods, and relates particularly, though not exclusively, to systems and/or methods for acquiring and analysing asset data for asset identification and verification purposes. More particularly, the present invention relates to an automated system and/or method for acquiring, aggregating and analysing asset data from multiple sources for asset identification, verification and/or information display purposes.

It will be convenient to hereinafter describe the invention in relation to an automated system and/or method for acquiring, aggregating and analysing intangible property asset data, in particular trade mark, brand name, design, company/business name, domain name and/or social media identifier asset data, from multiple sources for various intangible property asset identification, verification and/or information display purposes, however, it should be appreciated that the present invention is not limited to that use only. For example, the asset verification systems and/or methods of the present invention could also readily be used for other forms of intangible property assets, such as, e.g., patents, copyright works/material or plant breeders rights, or for identifying start-ups, influencers and/or bloggers, as well as for any suitable form of tangible property asset(s), such as, for example, vehicles, aircraft, watercraft, bicycles, jewellery and watches, and/or any other suitable form of asset that may require identification, verification and/or authentication for purposes such as research, registration, protection, use, valuation, sale, repair and/or replacement. A skilled person will appreciate many possible uses and modifications of the systems and/or methods of the present invention. Accordingly, the present invention as hereinafter described should not be construed as limited to any one or more of the specific examples provided herein, but instead should be construed broadly within the spirit and scope of the invention as defined in the description and claims that now follow.

### BACKGROUND

Any discussion of documents, devices, acts or knowledge in this specification is included to explain the context of the invention. It should not be taken as an admission that any of the material forms a part of the prior art base or the common general knowledge in the relevant art in Australia, or elsewhere, on or before the priority date of the disclosure herein.

Unless stated otherwise, throughout the ensuing description, the expression “asset(s)” is/are intended to refer to any suitable tangible or intangible item(s) of value that may require identification, verification and/or authentication for purposes, such as, for example, research, registration, protection, use, valuation, sale, repair and/or replacement. As has already been outlined above, suitable items of value may include, but are not limited to: registrable intellectual property rights, such as, for example, trade marks (including traditional and non-traditional trade marks), registered/industrial designs, patents, design patents, plant breeders rights and copyright works/material; non-registrable intellectual property rights, such as, for example, unregistered design rights, circuit layouts, copyright works/material and trade dress; domain names; company and business/trade names; intangible rights that an individual or entity claims right to by virtue or, for example, prior or continuous use, such as, for example, words, phrases, letters, numbers, sounds, scents, shapes, logos, pictures, images (both still and moving), videos, movies, aspects of packaging, designs, plant variety names, brand names, or a combination of these; social media, Internet or other communications network identifiers, handles or tags, such as, for example, Instagram handles, Twitter handles and hashtags; watches and jewellery; wine or spirits; works of art; memorabilia; collectables; weapons; property; and/or, import/export items, etc. A skilled person will appreciate these and other suitable item(s) of value, or combinations, substitutions, variations or alternatives thereof, applicable for use with the system and/or method of the present invention. Accordingly, the present invention should not be construed as limited to any one or more of the specific examples provided herein. Finally, the definition of the expression hereinbefore described is only provided for assistance in understanding the nature of the invention, and more particularly, the preferred embodiments of the invention as hereinafter described. Such definition, where provided, is merely an example of what the expression refers to, and hence, is not intended to limit the scope of the invention in any way.

The process of correctly identifying and verifying the authenticity of an asset for purposes such as research, registration, protection, use, valuation, sale or repair is often laborious and fraught with human errors, whether they be inadvertent or fraudulent errors. For example, users may register an Instagram handle or a business name believing the Instagram handle or business name are protected and do not infringe any other trader's Instagram handle or business name. However, at this first instance, users are generally failing to consider if their intended brand name may infringe a registered trademark. This unintentional infringement of trademark rights can lead to subsequent legal threats and battles, ultimately resulting in the possibility of a loss of the Instagram handle or the proposed business name. There is currently no convenient service for assisting start-up companies and influencers to decide and then build their personalised brand with the added protection that it does not infringe conflicting trademarks or other related intangible property rights.

In Australia, current trademark or brand name/identifier and related important data is available online from a large number of disparate, non-integrated and sometimes, non-verified data sources. For example, IP Australia (the Australian Intellectual Property Office), ASIC (the “Australian Securities & Investments Commission”), Domain Name Whois service providers, LinkedIn, Instagram and Facebook each contain numerous trade mark or brand name/identifier related data including, but not limited to: trademarks, including ownership information, goods/services and historical information related thereto; company and business names, including ownership and ACN/ABN (“Australian Company Number”/“Australian Business Number”) information; domain names (which may sometimes have hidden particulars); social media identifiers, such as, handles or tags; and, a lot of other business-related information. With that said, whilst IP Australia maintains a database of current and lapsed trademarks and this information is publicly available, searching of the Trade Marks Office official online database (“ATMOSS”) is a laborious and complicated process. Furthermore, a trademark can be unregistered and therefore not recorded on IP Australia's ATMOSS database, whereas unregistered trademarks still confer trademark rights to their owner by virtue of prior use and acquired reputation. Another source of important related information is the Personal Property Securities Register (or “PPSR”), an Australian Government agency, which maintains a national database that stores details of security interests registered against personal assets, including intellectual property rights, and provides that information to the public for a fee. Whilst these sources may provide specific data that can be readily searched, there is currently no service offering a reliable, robust system that delivers a consolidated data output with easy to use single reference for intangible property asset identification, verification and/or information display purposes.

The intellectual property and related intangible asset data available from these types of sites/sources is typical information which consumers and business industry personnel alike all require when, for example: researching a potential new trademark for a business or considering a new brand name or re-branding a business. Typically, a consumer wanting to make an informed decision about a new brand would need to seek out all of this information from the various sources on their own, including paying the necessary fees for any reports that are not available for free. Likewise, whilst intellectual property industry professionals often have ready access and search strategies for retrieving the intellectual property data held by agencies such as IP Australia and the PPSR, they generally still need to access one or more other sites or service providers to ascertain, for example, the claimed goods and/or services for a trademark, ownership and history of ownership of the trademark, etc. Regardless of whether it's a consumer, or intellectual property industry professional, doing the research, etc., the current process of retrieving the necessary intangible asset data is a manual process which involves one or more people manually entering required information, e.g., a trademark image or a word, etc., into the various sites or programs in order to retrieve the desired data. As with all manual data entry processes, input errors can lead to no or incorrect data being retrieved. This problem can be exacerbated when multiple sources need to be accessed and/or when attempting to obtain and enter unusual trademarks/brand names, such as, for example, peculiar words, and images, into these various sites or programs. Further difficulties may be encountered if a trader wishes to search for a non-traditional trademark, such as, for example, a sound, scent or an aspect of packaging or trade dress.

Even if we put aside the problems associated with manual data entry, and if we consider that all of the necessary intangible property asset data is readily available online from the types of sites and service providers outlined above, there is currently no way to determine whether the available data for a particular intangible property asset is actually correct or valid. That is, there is currently no way to readily differentiate between correct and incorrect (or fraudulent) data, nor is there any convenient means of interpreting administrative nuances, filtering our extraneous information, or making “human-like” predictions about the validity of the available data or intangible property asset itself.

A need therefore exists for an asset verification system and/or method, one which overcomes or alleviates one or more of the aforesaid problems associated with known sources of asset data, and/or procedures for obtaining and reviewing that data, or one which at least provides a useful alternative. More particularly, a need exists for an automated system and/or method for acquiring, aggregating and analysing asset data from multiple sources for asset identification, verification and/or information display purposes. In one form, it would be convenient to provide an automated system and/or method for acquiring, aggregating and analysing intangible property asset data from multiple sources for intangible property asset identification, verification and/or information display purposes. It would also be advantageous if such an automated system and/or method were able to provide a robust, reliable and easy to use single reference for intangible property asset information which could readily be used to verify intangible property asset authenticity, history and availability for use, etc., with a high degree of accuracy.

### SUMMARY

According to one aspect, the present invention provides a method for acquiring, aggregating and analysing asset data from multiple data sources for asset identification, verification and/or information display purposes, the method including the steps of: acquiring initial asset data for a selected asset from a first data source, the initial asset data including at least one identifier for the selected asset, and/or one or more word(s) and/or image(s) of the selected asset; utilising the initial asset data and/or the at least one identifier, to retrieve further predetermined asset data associated with the selected asset from two or more further data sources; aggregating and analysing the acquired/retrieved initial and further predetermined asset data, whilst also optionally acquiring, aggregating and analysing any further necessary asset data associated with the selected asset from the first and/or two or more further data sources; and, utilising artificial intelligence or machine learning to cross-check or vet the acquired/retrieved asset data in order to verify particulars of the selected asset; wherein the cross-checked or vetted asset data may then be used for identification, verification and/or information display purposes related to the selected asset.

Preferably, the first data source is a user data source, and wherein the two of more further data sources preferably include trusted and non-trusted data sources.

Preferably, the initial asset data for the selected asset includes at least the at least one identifier, and wherein the initial asset data and/or the further necessary asset data preferably includes a plurality of images of the selected asset if the selected asset includes multiple dimensions, aspects or forms, and, wherein if the selected asset is a multi-dimensional object or thing, the plurality of images of the selected asset preferably includes a plurality of images of the selected asset at differing angles.

In a practical preferred embodiment, the selected asset is preferably a selected intangible property asset, and wherein the at least one identifier for the selected intangible property asset preferably is at least one of: a word; a letter; a phrase; a number; an image (still or moving); a picture; a logo; a sound; a shape; a two-dimensional shape; a three-dimensional shape; a scent; a movement; a movie/video; a colour; a design; an aspect of packaging; a trade dress; a brand name; a trade mark; a company/business/trade name; a plant variety name; and/or, a combination of any of these aforementioned asset identifiers; and/or, a domain name; a social media, internet or other communications network identifier including a handle or a tag; and/or, an intangible property asset particular(s).

Preferably, the further predetermined asset data, and/or the further necessary asset data, associated with the selected intangible property asset includes both trusted and non-trusted intangible property asset data, obtained from the two or more trusted and non-trusted data sources, and wherein the trusted and non-trusted intangible property asset data for the selected intangible property asset preferably includes, but is not limited to: government or otherwise officially recorded intangible property asset data; intangible property asset ownership data; associated product and/or service intangible property asset data; and/or, general intangible property asset data available from general data source providers, including search engine and social media service providers.

Preferably, the step of utilising artificial intelligence or machine learning to cross-check or vet the acquired/retrieved intangible property asset data includes the use of an artificial intelligence algorithm or neural network in association, or combination with, at least object detection technology, in order to verify particulars of the selected intangible property asset.

It is also preferred that the step of utilising artificial intelligence or machine learning to cross-check or vet the acquired/retrieved intangible property asset data, utilising the artificial intelligence algorithm or neural network in association, or combination with, the at least object detection technology, in order to verify particulars of the selected intangible property asset, preferably includes comparing and contrasting the acquired/retrieved intangible property asset data with the known reliable/trusted data sources in order to differentiate between accurate or false, or fraudulent, intangible property asset data, and/or authentic or non-authentic intangible property assets, and/or related or non-related particulars, etc., thereof.

Similarly, it is also preferred that the step of utilising artificial intelligence or machine learning to cross-check or vet the acquired/retrieved intangible property asset data, utilising the artificial intelligence algorithm or neural network in association, or combination with, the at least object detection technology, also preferably includes: interpreting any administrative nuances associated with the acquired/retrieved intangible property asset data; and/or, filtering out any extraneous information/data contained within the acquired/retrieved intangible property asset data.

Preferably, the asset identification, verification and/or information display purposes include, but are not limited to: selling or purchasing a selected intangible property asset; exploring or researching a selected intangible property asset, and/or features/specifications thereof, including whether or not the selected intangible property asset is available for use, registration and/or protection; recording or modifying a selected intangible property asset security interest; proceeding to register or protect a selected intangible property asset; and/or, proceeding to engage a professional or service provider to assist with further matters associated with a selected intangible property asset.

According to a further aspect, the present invention provides a non-transitory computer readable medium storing a set of instructions that, when executed by a machine, cause the machine to execute a method for acquiring, aggregating and analysing asset data from multiple data sources for asset identification, verification and/or information display purposes, the method including the steps of acquiring initial asset data for a selected asset from a first data source, the initial asset data including at least one identifier for the selected asset, and/or one or more word(s) and/or image(s) of the selected asset; utilising the initial asset data and/or the at least one identifier, to retrieve further predetermined asset data associated with the selected asset from two or more further data sources; aggregating and analysing the acquired/retrieved initial and further predetermined asset data, whilst also optionally acquiring, aggregating and analysing any further necessary asset data associated with the selected asset from the first and/or two or more further data sources; and, utilising artificial intelligence or machine learning to cross-check or vet the acquired/retrieved asset data in order to verify particulars of the selected asset; wherein the cross-checked or vetted asset data may then be used for identification, verification and/or information display purposes related to the selected asset.

According to yet a further aspect, the present invention also provides a system for acquiring, aggregating and analysing asset data from multiple data sources for asset identification, verification and/or information display purposes, the system including: one or modules or applications for acquiring initial asset data for a selected asset from a first data source, the initial asset data including at least one identifier for the selected asset, and/or one or more word(s) and/or image(s) of the selected asset; one or more modules of applications for utilising the initial asset data and/or the at least one identifier, to retrieve further predetermined asset data associated with the selected asset from two or more further data sources; one or more modules or applications for aggregating and analysing the acquired/retrieved initial and further predetermined asset data, whilst also optionally acquiring, aggregating and analysing any further necessary asset data associated with the selected asset from the first and/or two or more further data sources; and, one or more artificial intelligence or machine learning modules of applications for cross-checking or vetting the acquired/retrieved asset data in order to verify particulars of the selected asset; wherein the cross-checked or vetted asset data may then be used for identification, verification and/or information display purposes related to the selected asset.

These and other essential or preferred features of the present invention will be apparent from the description that now follows.

### BRIEF DESCRIPTION OF THE DRAWINGS

In order that the invention may be more clearly understood and put into practical effect there shall now be described in detail preferred asset verification systems and/or methods made in accordance with the invention. The ensuing description is given by way of non-limitative examples only and is with reference to the accompanying drawings, wherein:

FIG. 1 is a block diagram of an intangible property asset verification system made in accordance with a preferred embodiment of the present invention;

FIG. 2 is a flow diagram illustrating a preferred embodiment of an intangible property asset verification method which is suitable for use with the preferred intangible property asset verification system shown in FIG. 1;

FIGS. 3a to 3c show exemplary graphical user interfaces (hereinafter simply referred to as “GUI(s)”) which illustrate, in preferred steps, how intangible property asset input data may be scanned and/or captured by a user operable device in accordance with the preferred intangible property asset verification system and/or method shown in FIGS. 1 and 2;

FIGS. 4a and 4b show exemplary GUIs which illustrate, in preferred steps, how a user may access various options or features of the preferred intangible property asset verification system and/or method shown in FIGS. 1 and 2;

FIGS. 5a and 5b show exemplary GUIs which illustrate, in preferred steps, how an intangible property asset may be listed for sale in accordance with the preferred intangible asset verification system and/or method shown in FIGS. 1 and 2;

FIGS. 6a to 6e illustrate, in preferred forms, how a user may explore or research the features of an intangible property asset report that may be produced in accordance with the preferred intangible property asset verification system and/or method shown in FIGS. 1 and 2;

FIG. 7 is a block diagram illustrating how an intangible property asset security interest may be recorded or managed in accordance with the preferred intangible property asset verification system and/or method shown in FIGS. 1 and 2; and,

FIG. 8 shows an exemplary GUI which illustrates how the preferred intangible property asset verification system and/or method shown in FIGS. 1 and 2 may be used to navigate and display a verification report providing details of intangible property asset information and options for performing further steps of the preferred intangible property asset verification system and/or method shown in FIGS. 1 and 2.

### DETAILED DESCRIPTION

In the following detailed description of the invention, reference is made to the drawings in which like reference numerals refer to like elements throughout, and which are intended to show by way of illustration specific embodiments in which the invention may be practiced. It is to be understood that other embodiments may be utilised and that procedural and/or structural changes may be made without departing from the spirit and scope of the invention.

Unless specifically stated otherwise as apparent from the following discussion, it is to be appreciated that throughout the description, discussions utilising terms such as “processing”, “computing”, “calculating”, “acquiring”, “transmitting”, “aggregating”, “receiving”, “retrieving”, “identifying”, “determining”, “analysing”, “manipulating” and/or “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Discussions regarding apparatus for performing the operations of the invention are provided herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable read-only memory (EPROMs), electrically erasable programmable read-only memory (EEPROMs), magnetic or optical cards, or any type of media suitable for storing electronic instructions, and each coupled to a computer system bus.

The software modules, engines or applications, and displays or GUIs presented or discussed herein are not inherently related to any particular computer or other apparatus. Various general purpose systems may be used with programs in accordance with the teachings herein, or it may prove convenient to construct more specialised apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

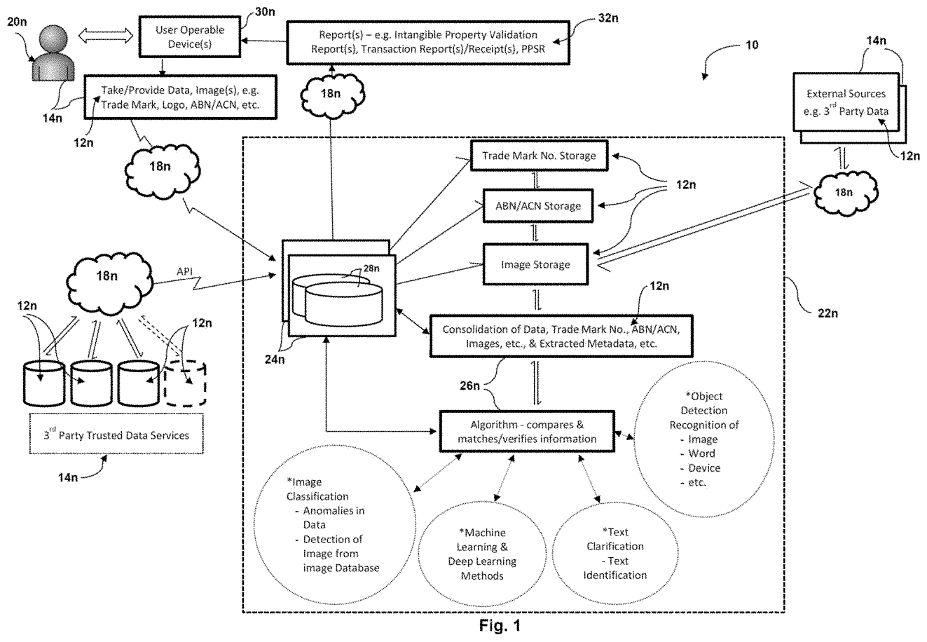

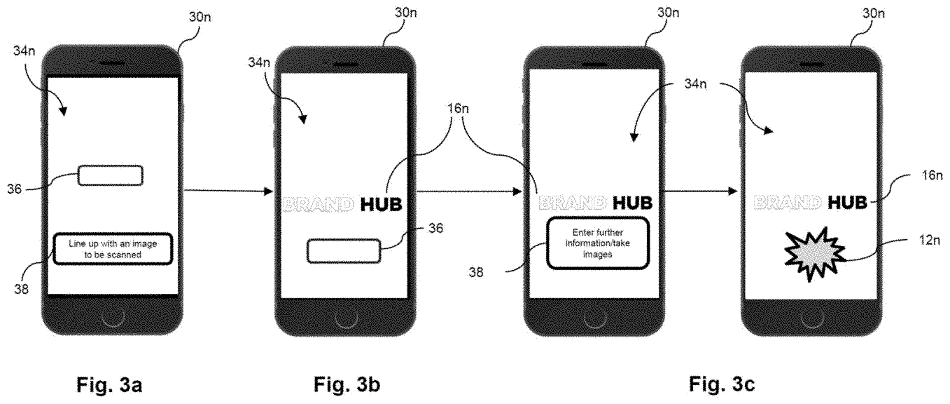

In FIG. 1 there is shown a preferred system 10 for acquiring, aggregating and analysing asset data 12ₙ from multiple data sources 14ₙ for various asset 16ₙ (such as, for example, an intangible property asset 16ₙ as shown in FIGS. 3b, 3c, 4a, 5a, 6a to 6e & 8) identification, verification and/or information display purposes. System 10 is suitable for use over a communications network 18ₙ, such as, for example, the Internet or web 18ₙ, as shown. It should be understood however, that system 10 of the present invention is not limited to that use only.

In the preferred embodiments shown in the drawings, system 10 is specifically configured for acquiring, aggregating and analysing intangible property asset data 12ₙ for various intangible property asset 16ₙ identification, verification and/or information display purposes. Examples of suitable intangible property assets 16ₙ and their associated intangible property asset data 12ₙ include: a word; a letter; a phrase; a number; an image (still or moving); a picture; a logo; a sound; a shape; a two-dimensional shape; a three-dimensional shape; a scent; a movement; a movie/video; a colour; a design; an aspect of packaging; a trade dress; a brand name; a trade mark; a company/business/trade name; a plant variety name; and/or, a combination of any of these aforementioned examples; and/or, a domain name; a social media, internet or other communications network identifier including a handle or a tag; and/or, any other suitable intangible property asset(s) or particular(s).

In FIG. 1, the preferred intangible property asset 16ₙ is a trademark or brand name, and the associated intangible property asset identifying data 12ₙ may preferably include a Trade Mark No., an ABN/ACN and an image/logo, as shown. In the context of this preferred form of intangible property asset 16ₙ/data 12ₙ, and as is shown in FIG. 1, the multiple data sources 14ₙ preferably include, but are not limited to: user 20ₙ data sources 14ₙ; trusted third-party data sources 14ₙ, such as, for example, government or otherwise officially recorded regulated data sources (e.g. IP Australia, ASIC, domain name Whois service providers, the PPSR or similar service provider(s), etc.); and, non-trusted third-party data sources available from general data source providers, including search engine and social media service providers 14ₙ, such as, for example, Google, Bing, ImageNet (by Stanford and Princeton Universities), Wikipedia, Instagram, Pinterest, Facebook, Twitter, etc. Again, in the context of this preferred form of intangible property asset 16ₙ/data 12ₙ, and as is shown throughout the drawings, the various intangible property asset 16ₙ identification, verification and/or information display purposes preferably include, but are not limited to: selling or purchasing an intangible property asset 16ₙ; exploring or researching a selected intangible property asset 16ₙ, and/or features/specifications thereof, including whether or not the selected intangible property asset is available for use, registration and/or protection; recording or modifying a selected intangible property asset 16ₙ security interest; proceeding to register or protect a selected intangible property asset 16ₙ; and/or, proceeding to engage a professional or service provider to assist with further matters associated with a selected intangible property asset 16ₙ. Although specific intangible property asset 16ₙ embodiments are shown and described herein, it should be appreciated that the present invention is not limited to that use, or those examples, only.

System 10 includes at least one network server 22ₙ, which includes at least one computing device 24ₙ, which hosts and/or maintains a plurality of tools or applications 26ₙ (such as, for example, software and/or hardware modules or applications 26ₙ, etc.) and databases/storage devices 28ₙ, that together provide a means for acquiring, aggregating and analysing intangible property asset data 12ₙ, from the preferred multiple data sources 14ₙ for the various preferred intangible property asset 16ₙ identification, verification and/or information display purposes outlined above.

Network server 22ₙ is configured to receive/transmit data, including intangible property asset data 12ₙ, from/to the trusted and non-trusted third-party data sources 14ₙ and at least one user operable device 30ₙ, via communications network 18ₙ. The term “user operable device(s) 30ₙ” refers to any suitable type of computing device or software application, etc., capable of transmitting, receiving, capturing, conveying and/or displaying data (including intangible property asset data 12ₙ) as described herein, including, but not limited to, a mobile or cellular phone, a smart phone, an App (e.g. iOS or Android, etc.) for a smart phone, a smart watch or other wearable electronic device, an augmented reality device (such as, for example, an augmented reality headset, eyeglasses or contact lenses, etc.), a connected Internet of Things (“IoT”) device; a Personal Digital Assistant (PDA), and/or any other suitable computing device, as for example a server, personal, desktop, tablet, or notebook computer.

User operable devices 30ₙ are each configured to be operated by at least one user 20ₙ of system 10. The term “user 20ₙ” refers to any person in possession of, or stationed at, at least one user operable device 30ₙ who is able to operate the user operable device 30ₙ in order to transmit/receive data, including intangible property asset data 12ₙ, and/or display intangible property asset data 12ₙ, intangible property asset(s) 16ₙ (including features and specifications thereof, etc.), reports and other necessary information 32ₙ within at least one GUI(s) 34ₙ installed on the user operable device 30ₙ. User operable devices 30ₙ may include various types of software and/or hardware module(s) (not shown) required for capturing, transmitting, receiving, analysing, processing, conveying and/or displaying data, including intangible property asset data 12ₙ to/from network server 22ₙ, via communications network 18ₙ, in accordance with system 10 including, but not limited to: at least one system 10 specific GUI 34ₙ application(s) or App(s), which could simply be an operating system installed on user operable device 30ₙ that is capable of actively transmitting, receiving, capturing, conveying and/or displaying data on a screen without the need of a specific separately installed GUI 34ₙ, etc.; a plurality of tools or applications (not shown, but which may be, for example, software and/or hardware modules or applications, etc.) that provide a means of identifying, capturing, retrieving, analysing and/or processing intangible property asset data 12ₙ; monitor(s) (touch sensitive or otherwise); camera(s) for capturing still or moving intangible property asset data 12ₙ, or for creating a system 10 generated augmented reality environment (not shown), etc.; GUI pointing device(s); keyboard(s); sound capture device(s) (e.g. one or more microphone devices for capturing a user's 20ₙ voice commands, or for capturing intangible property asset data 12ₙ, etc.); sound emitting device(s) (e.g. one or more loudspeakers and/or text to speech converters, etc., for audibly conveying intangible property asset data 12ₙ, reports 32ₙ, etc., to a user 20ₙ); gesture capture device(s) (e.g. one or more cameras for capturing a user's 20ₙ gesture commands, etc.); augmented reality device(s) (e.g. glasses, etc.); smart watch(es); and/or, any other suitable data acquisition, transmission, capture, conveying and/or display device(s) (not shown).

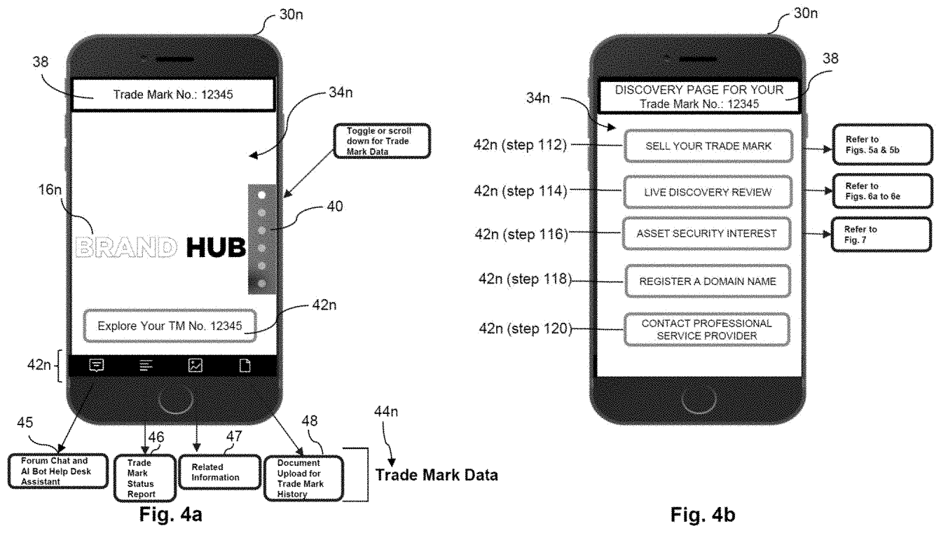

Intangible property asset data 12ₙ may be captured by a user operable device 30ₙ directly by way of, e.g., a user 20ₙ utilising their finger(s), thumb(s), a keyboard, a GUI pointing device(s), integrated camera(s), etc., or a voice command, physical motion or gesture, etc. Alternatively, intangible property asset data 12ₙ may be captured by way of a user 20ₙ utilising a user interface (not shown), e.g., a smart watch, augmented reality device, external camera(s), etc., connected to the user operable device 30ₙ. The process of capturing intangible property asset data 12ₙ may also not involve any user 20ₙ directed input at all, but instead could be submitted to network server 22ₙ, as desired by a user operable device 30ₙ itself, based on algorithms, e.g. predictive algorithms, residing on the user operable device(s) 30ₙ, which may determine that an intangible property asset 16ₙ is in need of scanning, etc., in order to capture intangible property asset data 12ₙ, by way of, for example, analysing a user's 20ₙ behaviour, their geographical location, or by the position of the intangible property asset 16ₙ relative to the user operable device 30ₙ, etc. Similarly, intangible property asset data 12ₙ and any other applicable associated data 32ₙ (e.g., application and/or registration numbers, images, etc.) may be displayed to a user 20ₙ by way of one or more screens or monitors of a user operable device 30ₙ or may be displayed to the user 20ₙ by way of a user interface (not shown), e.g., a smart watch, augmented reality device, etc., connected to the user operable device 30ₙ. In yet a further embodiment, some or all of the intangible property asset data 12ₙ may be displayed to a user 20ₙ by way of one or more screens or monitors of a user operable device 30ₙ (or may be displayed to the user 20ₙ by way of a user interface (not shown), e.g. a smart watch, augmented reality device, etc., connected to the user operable device 30ₙ), whilst part of the intangible property asset data 12ₙ may be audibly conveyed to the user 20ₙ by way of one or more sound emitting device(s) of (or connected to) the user operable device 30ₙ. For example, images (still or moving) of an intangible property asset 16ₙ may be displayed (by way of, for example, a screen/monitor, or an augmented reality device(s), etc.) to a user 20ₙ by way of, for example, the GUI 34ₙ of FIG. 4a, with the corresponding intangible property asset data 12ₙ, e.g. the intangible property 16ₙ information, such as brand name, trade mark, or other features, etc., being audibly conveyed to the user 20ₙ automatically, or upon request, by way of one or more sound emitting device(s) of (or connected to) the user operable device 30ₙ (or augmented reality device(s), etc.). It will be appreciated that where user interfaces (not shown), such as, for example, a smart watch and/or an augmented reality device, are referred to as being interfaces that may be connected (wired or wirelessly) to a user operable device 30ₙ, such interfaces could themselves be a user operable device 30ₙ in accordance with the present invention. That is, a device, such as, for example, an augmented reality device (not shown) could be a standalone user operable device 30ₙ, or passive display device, suitable for use in accordance with system 10 of the present invention.

Network server 22ₙ is configured to communicate with user operable devices 30ₙ (and hence, user 20ₙ) and trusted and non-trusted third-party data sources 14ₙ via any suitable communications connection or network 18ₙ (hereinafter referred to simply as a “network(s) 18ₙ”). Trusted and non-trusted third-party data sources, or service provider(s) 14ₙ, is/are configured to transmit and receive data to/from network server 22ₙ, via network(s) 18ₙ. User operable devices 30ₙ are configured to transmit, receive capture and/or display data, including intangible property asset data 12ₙ, from/to network server 22ₙ, via network(s) 18ₙ. Each user operable device 30ₙ and trusted and non-trusted data service provider 141 may communicate with network server 22ₙ via the same or a different network 18ₙ. Suitable networks 18ₙ include, but are not limited to: a Local Area Network (LAN); a Personal Area Network (PAN), as for example an Intranet; a Wide Area Network (WAN), as for example the Internet; a Virtual Private Network (VPN); a Wireless Application Protocol (WAP) network, or any other suitable telecommunication network, such as, for example, a GSM, 3G, 4G, 5G, etc., network; Bluetooth network; and/or any suitable WiFi network (wireless network). Network server 22ₙ, trusted and non-trusted third-party data sources, or service providers 14ₙ, and/or user operable device 30ₙ, may include various types of hardware and/or software necessary for communicating with one another via network(s) 18ₙ, and/or additional computers, hardware, software, such as, for example, routers, switches, access points and/or cellular towers, etc. (not shown), each of which would be deemed appropriate by persons skilled in the relevant art.

For security purposes, various levels or security, including hardware and/or software, such as, for example, application programming interfaces (or “APIs”, as shown in, for example, FIGS. 1 & 7), firewalls, tokens, two-step authentication (not shown), etc., may be used to prevent the unauthorized access to, for example, network server 22ₙ and/or third-party data sources 14ₙ. Similarly, network server 22ₙ may utilise security (e.g., hardware and/or software—not shown) to validate access by user operable devices 30ₙ, or when exchanging information between/with third-party data sources 14ₙ. It is also preferred that network server 22ₙ performs validation functions to ensure the integrity of data transmitted between third-party data sources 14ₙ and/or user operable devices 30ₙ. A person skilled in the relevant art will appreciate such technologies and the many options available to achieve a desired level of security and/or data validation, and as such a detailed discussion of same will not be provided. Accordingly, the present invention should be construed as including within its scope any suitable security and/or data verification technologies as would be deemed appropriate by a person skilled in the relevant art.

Communication and/or data transfer between network server 22ₙ, trusted and non-trusted data sources 14ₙ and/or user operable devices 30ₙ, may be achieved utilising any suitable communication, software architectural style, and/or data transfer protocol, such as, for example, FTP, Hypertext Transfer Protocol (HTTP), Representational State Transfer (REST); Simple Object Access Protocol (SOAP); Electronic Mail (hereinafter simply referred to as “e-mail”), Unstructured Supplementary Service Data (USSD), voice, Voice over IP (VoIP), Transfer Control Protocol/Internet Protocol (hereinafter simply referred to as “TCP/IP”), Short Message Service (hereinafter simply referred to as “SMS”), Multimedia Message Service (hereinafter simply referred to as “MMS”), any suitable Internet based message service, any combination of the preceding protocols and/or technologies, and/or any other suitable protocol or communication technology that allows delivery of data and/or communication/data transfer between network server 22ₙ, third-party data sources 14ₙ and/or user operable devices 30ₙ, in accordance with system 10. Similarly, any suitable data transfer or file format may be used in accordance with system 10, including (but not limited to): text; a delimited file format, such as, for example, a CSV (Comma-Separated Values) file format; a RESTful web services format; a JavaScript Object Notation (JSON) data transfer format; a PDF (Portable Document Format) format; and/or, an XML (Extensible Mark-Up Language) file format.

Access to network server 22ₙ and the transfer of information between network server 22ₙ, third-party data sources 14ₙ and/or user operable devices 30ₙ, may be intermittently provided (for example, upon request), but is preferably provided “live”, i.e. in real-time, or as close to live/real-time as possible.

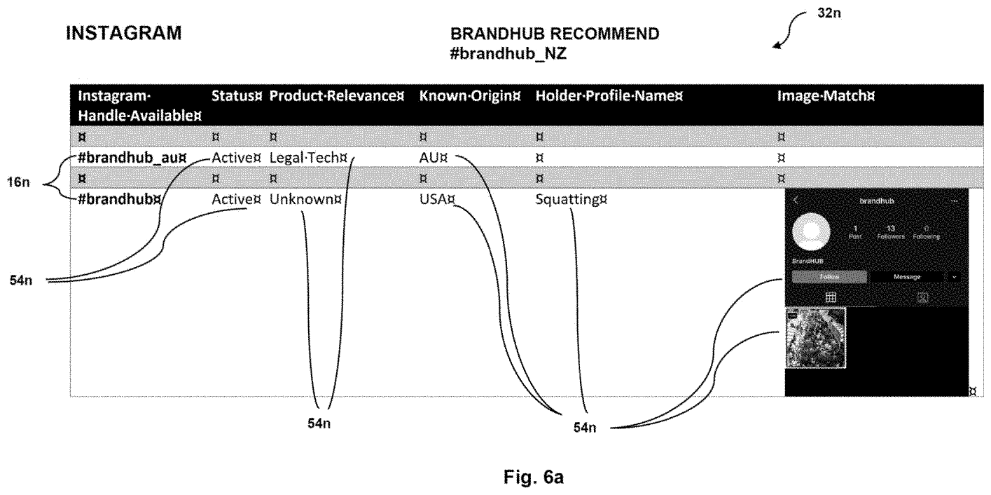

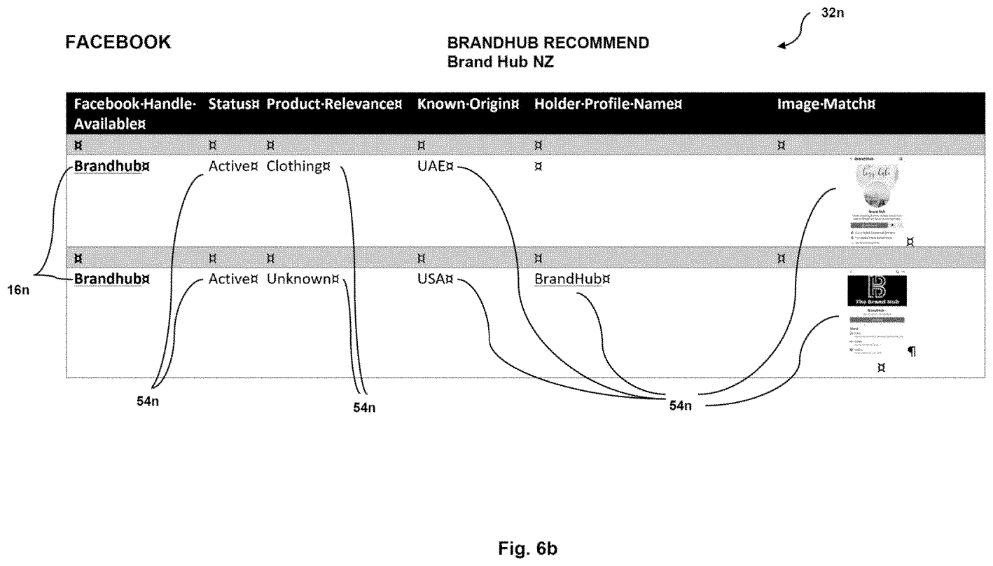

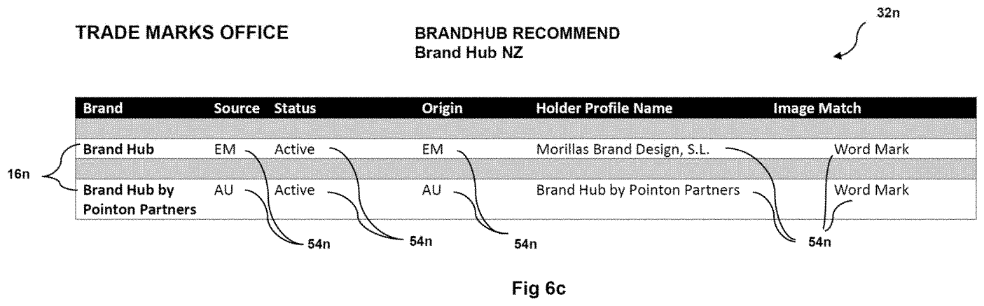

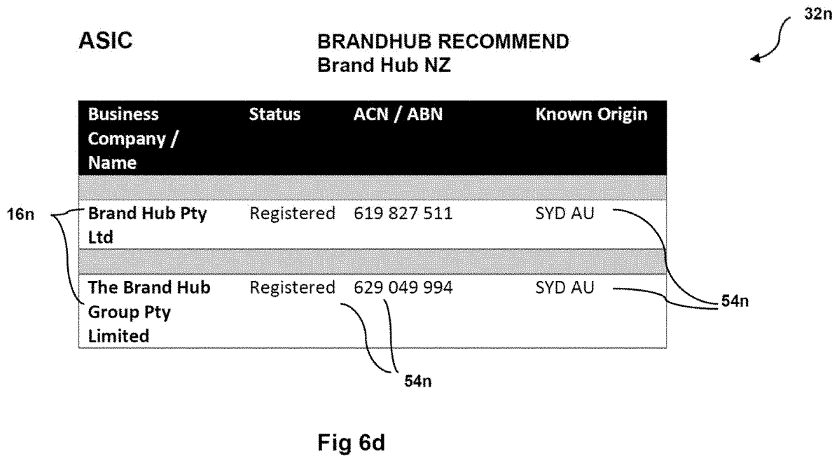

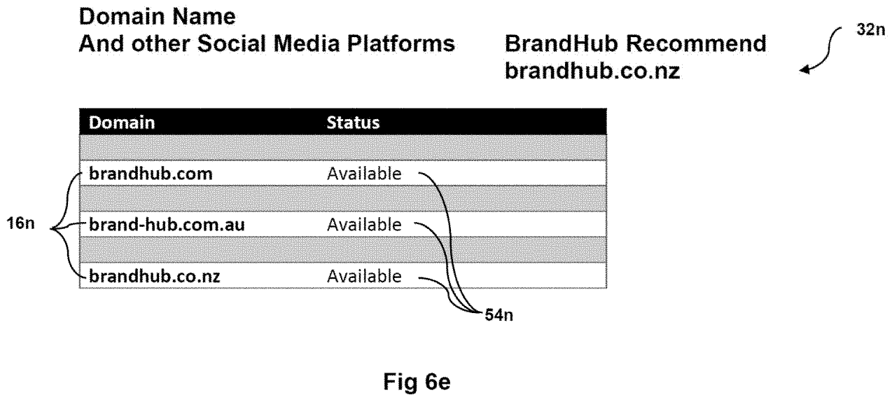

As already outlined above, system 10 is designed to provide an automated system/process for acquiring, aggregating and analysing intangible property asset data 12ₙ from multiple data sources 14ₙ for various intangible property asset 16ₙ identification, verification and/or information display purposes. To do this, at the core of system 10, network server 22ₙ provides artificial intelligence in the form of one or more artificial intelligence algorithm(s) or module(s)/application(s) 26ₙ (herein after simply referred to as “AI module(s) 26ₙ”) which use machine or deep learning in association, or combination with, various other software and/or hardware modules or applications 26ₙ, including, but not limited to, object detection module(s) 26ₙ and/or optical character recognition or reader (commonly known as “OCR”) modules 26ₙ, to acquire, aggregate and analyse intangible property asset data 12ₙ from the preferred multiple data sources or service providers 14ₙ, so as to then, for example, differentiate between correct and incorrect data 12ₙ, differentiate between related and unrelated data 12ₙ, interpret administration nuances, filter out extraneous information/data 12ₙ and/or make ‘human like’ predictions about the validity of the data 12ₙ, and/or intangible property assets 16ₙ. Put another way, the AI module(s) 26ₙ, and other module(s) 26ₙ of system 10, enable network server 22ₙ to collate intangible property asset data 12ₙ (and any other necessary related data), compare and contrast that data 12ₙ with predetermined asset data 12ₙ obtained from reliable data sources 14ₙ, etc., to differentiate between accurate or false (or fraudulent) data 12ₙ and/or authentic or non-authentic and/or related or un-related intangible property assets 12ₙ (or words, images, pictures, business names, domain names, etc., thereof). Thus, system 10 can preferably be used, inter alia, to collate authenticated intangible property asset 16ₙ/data 12ₙ, using databases 14ₙ and the various module(s)/application(s) 26ₙ, and as a result thereof, can provide a user 20ₙ with a report 32ₙ (see, for example, FIGS. 6a to 6e) outlining whether or not a selected intangible property asset 16ₙ is available for use, registration and/or protection. As will be described in further detail hereinafter, the resulting preferred report 32ₙ can be used to engage an intellectual property industry professional or a service provider (such as a Trade Marks Attorney, a graphic designer, a photographer, or a marketing specialist—not shown) to assist with further matters associated with a selected intangible property asset 16ₙ. Using the preferred report 32ₙ, an intellectual property industry professional or a service provider (not shown) may then assist with filing and/or registration of an intangible property asset 16ₙ—if it is a registrable intangible property asset 16ₙ, such as, for example, an intellectual property right or a domain name, etc.—or may use the preferred report 32ₙ to, for example: assess the likelihood of an infringement; use it as a basis for seeking consent to the use of an intangible property asset 16ₙ; and/or, lodge an application for revocation of a trade mark for non-use, etc. Furthermore, the preferred report 32ₙ could also preferably be used as a basis for licensing and/or franchising opportunities, etc.

In addition, and as will be described in further detail below, by being an automated streamlined process, system 10 is able to replace current manual, time consuming processes, with a new process(es) which is/are faster, more comprehensive, accurate and less prone to human errors. That is, system 10 is preferably completely, or at least substantially, automated; streamlining the entire process of collating intangible property asset data 12ₙ (and any associated data/information) from multiple data sources 14ₙ, whilst eliminating arduous paperwork, multiple databases/sources, manual input errors and lengthy wait times, etc.

As already briefly outlined above, network server 22ₙ and user operable device(s) 30ₙ, may each host and/or maintain a plurality of modules or applications 26ₙ (not shown in the context of user operable devices 30ₙ) and database(s)/storage device(s) 28ₙ (again, not shown in the context of user operable devices 30ₙ) that enable multiple aspects of system 10 to be provided over network(s) 18ₙ. These module(s) or application(s) 26ₙ and database(s)/storage device(s) 28ₙ may include, but are not limited to: (i) one or more user operable device 30ₙ based module(s) or application(s) (not shown) for capturing, transmitting, receiving, conveying and/or displaying intangible property asset data 12ₙ (and any associated data, reports, etc. 32ₙ, as described herein), to/from network server 22ₙ, via network(s) 18ₙ, wherein the user operable device 30ₙ based module(s)/application(s) (not shown) preferably include(s) at least: an OCR component or application capable of recognising, capturing, converting and/or transmitting intangible property asset 16ₙ alphanumeric (or symbol, etc.) identifier(s)/marker(s)/image(s) 12ₙ (not shown—but which may be, for example, a trade mark, a brand name, a business name, a domain name, a logo, an intellectual property right application and/or registration number, ABN/ACN numbers, etc.)—the OCR component/application preferably being operable to capture the intangible property 16ₙ information/identifier(s)/marker(s)/image(s) 12ₙ either by pointing a camera, etc. (which may be integral with user operable device 30ₙ, or coupled therewith) at an intangible property asset 16ₙ in real-time, or by analysing a previously captured image(s) and/or word(s) 12ₙ (still or moving) of an intangible property asset 16ₙ; an image and/or word(s) 12ₙ (still or moving) capture component or application capable of capturing, storing and/or transmitting one or more images 12ₙ of the intangible property asset 16ₙ, and/or component parts thereof—the image capture component/application may simply involve the use of a camera, etc. (which may be integral with user operable device 30ₙ, or coupled therewith) to take/capture image(s)/word(s) 12ₙ of an intangible property asset 16ₙ, or may involve a more technical object detection process(es) which recognises words, numbers, images or pictures or a combination of these, etc., of an intangible property asset(s) 16ₙ, if required/desired; and, a GUI 34ₙ component or application which acts as an interface for user(s) 20ₙ to use system 10—the GUI 34ₙ component or application preferably being capable of selectively operating (either automatically or upon request from a user 20ₙ) the OCR and image capture components or applications, as well as being capable of displaying intangible property asset data 12ₙ, intangible property asset(s) 16ₙ (including features and particulars thereof, etc.), reports and other necessary information 32ₙ to a user(s) 20ₙ of system 10; (ii) one or more network server 22ₙ based module(s) or application(s) 26ₙ, and database(s)/storage device(s) 28ₙ, for interfacing with user operable device(s) 30ₙ, and trusted and non-trusted third-party data sources or service providers 14ₙ (which may require the use of APIs as shown in, for example, FIGS. 1 & 7), for the purpose of acquiring, aggregating, storing, modifying, indexing, transmitting and/or receiving, etc., intangible property asset data 12ₙ (and any other necessary data, reports, etc. 32ₙ), as required, in accordance with the present invention as described herein; (iii) one or more network server 22ₙ based optical detection and/or OCR module(s) or application(s) 26ₙ for analysing and recognising particulars (including, but not limited to: a word/number/picture/image/logo or a combination of these of an intangible property asset 16ₙ, its features, colours, shades etc., and/or identifier(s)/marker(s)/image(s) 12ₙ of an intangible property asset 16ₙ, etc.) of intangible property assets 16ₙ shown/provided in images/words 12ₙ (whether they be live, stored, still or moving images/words 12ₙ, etc.) or other forms of intangible property asset data 12ₙ, acquired from user 20ₙ data sources 14ₙ, and trusted and/or non-trusted third-party data sources 14ₙ (and which data 12ₙ may have been previously stored in database(s)/storage device(s) 28ₙ, of network server 22ₙ, using the one or more module(s) of application(s) 26ₙ described above with reference to (ii)); and/or, (iv) one or more network server 22ₙ based AI module(s) 26ₙ which, as already briefly described above, use machine or deep learning methods to analyse and verify intangible property asset data 12ₙ, along with interpreting administrative nuances and filtering out extraneous information/data 12ₙ, etc., to collectively make ‘human-like’ predictions about the authenticity or validity of intangible property asset data 12ₙ, intangible property assets 16ₙ and/or particulars thereof, in accordance with the present invention.

Although separate modules, applications or engines (e.g. module(s)/application(s) 26ₙ and database(s)/storage device(s) 28ₙ described above with reference to (i) to (iv)) have been outlined (with reference to both network server 22ₙ and user operable device(s) 30ₙ), each for effecting specific preferred aspects (or combinations thereof) of system 10, it should be appreciated that any number of modules/applications/engines/databases/storage devices for performing any one, or any suitable combination of, aspects of system 10, could be provided (wherever required) in accordance with the present invention. For example, whilst separate module(s) (iii) & (iv) 26ₙ have been described above, those module(s) 26ₙ could be combined into a single module 26ₙ in accordance with the present invention. A person skilled in the relevant art will appreciate many such module(s)/application(s)/engine(s) and database(s)/storage device(s) embodiments, modifications, variations and alternatives therefor, and as such the present invention should not be construed as limited to any of the examples provided herein and/or described with reference to the drawings.

AI module(s) 26ₙ, of network server 22ₙ, of system 10 of the present invention, may utilise any suitable machine or deep learning techniques or algorithms, etc., in order to perform its various functions or processes as described herein. However, it has been found that an AI module(s) 26ₙ which uses a Deep Learning (“DL”) model called ResNet (or “Residual Neural Network”), a deep convolutional artificial neural network, is particularly well suited for searching and verifying intangible property asset data 12ₙ, etc., in accordance with system 10 of the present invention. A skilled person will appreciate ResNet and many other machine or deep learning algorithms, etc., which could be used in accordance with the present invention. Accordingly, the present invention should not be construed as limited to the specific example as provided herein.

In a deep convolutional neural network (herein after simply referred to as “NN”), several unique layers are stacked (or consolidated) and are trained to develop a model for the problem to be solved—in this case intangible property asset 16ₙ/data 12ₙ verification. The NN learns several low/mid/high level features at the end of its layers. With Residual learning, instead of trying to learn some features, the NN tries to learn some residual. Residual can be simply understood as subtraction of features learned from input of that layer. ResNet does this using shortcut connections (directly connecting input of nth layer to some (n+x)th layer. It has been proven that training this form of NN is easier than training simple deep convolutional NNs and also the problem of degrading accuracy is resolved.

In accordance with a preferred embodiment of the present invention, a ResNet50 NN may be adopted, and then modified/refined/enhanced so as to be suitable for use as (or part of) AI module(s) 26ₙ, of network server 22ₙ, of system 10. A ResNet50 NN is a NN trained on more than a million images from the ImageNet database. By default, a ResNet50 NN is 50 layers deep and can classify images into 1000 object categories, such as keyboard, mouse, pencil, and many animals. As a result, the ResNet50 NN has learned rich feature representations for a wide range of images. That NN has an image input size of 224-by-224 by default. Using that ResNet50 architecture, an AI module(s) 26ₙ model can be created to classify and verify intangible property assets 16ₙ/data 12ₙ, such as, for example, trademarks, brand names, designs, company/business names, domain names and/or social media identifiers, etc. The AI module(s) 26ₙ could be configured/trained to classify a plurality of images of intangible property assets 16ₙ. To do this, the AI module(s) 26ₙ could be trained with a training set of data from data sources 14ₙ that include the likes of Google, WordNet, Word Sense Disambiguation (WSD), etc.; that each contain images 12ₙ, etc., depicting commonly recognised objects. The AI module(s) 26ₙ could be trained to match matching objects in an image to other instances of that object in other images as well as match it to a corresponding word or description. The AI module(s) 26ₙ could then be broken up into its 50 layers. Each of the layers having a unique purpose to detect and extract unique image characteristics of the intangible property asset 16ₙ/data 12ₙ, including its words, logos, devices, shape, contours, features, etc., that are unique to each image 12ₙ at a pixel level. To then hone in on the detection of a chosen image, a number of the layers of the AI module(s) 26ₙ could be modified and enhanced, in particular the “Classify layer” which consolidates then categorises the previous 49 layers from the ResNet50 model to uniquely identify an object depicted in the image 12ₙ. After the initial training, the AI module(s) 26ₙ could be further refined and enhanced by providing further images 12ₙ for recognition which would result in the AI module(s) 26ₙ correctly recognising images 12ₙ and detecting these as corresponding to various intangible property assets 16ₙ (such as, for example, trademarks, brand names, etc.) with a high degree of accuracy. Such an AI module(s) 26ₙ should then be able to either correctly identify whether a selected intangible property asset 16ₙ already exists and/or is being in use by another trader(s), or whether the selected intangible property asset 16ₙ is a new asset 16ₙ, that has not been in use and/or is not present on other data sources (such as, for example, IP Australia or social media websites 14ₙ). To improve the accuracy of preferred AI module(s) 26ₙ, of preferred system 10, the word(s)/image(s) 12ₙ that are used in the preliminary/further experimental phases of the development/training/refining of the AI module(s) 26ₙ would be carefully chosen so as to ensure that the AI Module(s) 26ₙ could readily detect intangible property asset(s) 16ₙ, such as, for example, trademarks, brand names, images, logos, colours, devices, etc., both in natural and artificial light conditions, and at varying angles, positions, distances and pixel levels/quality, etc. In addition, so as to ensure that the AI module(s) 26ₙ was not relying on any intangible property asset 16ₙ indicia for identification/verification purposes, the training/test images 12ₙ would be artificially stripped of any recognisable branding or other indicia (e.g., associated ownership or product/business details, etc.). This should then result in the AI module(s) 26ₙ only being able to identify and verify intangible property asset(s) 16ₙ based on the actual image, shape, colour, logo, device, etc (collectively, intangible property asset data 12ₙ). Further, it will be appreciated by a skilled person that although ResNet50 NN could be used for preferred AI module(s) 26ₙ, other resources, such as some pre-canned AWS, Google ML models for generic image classification could also be used.

Ongoing training and refinement/enhancement of AI module(s) 26ₙ, using the same or similar processes/techniques as those outlined above, using an abundance of additional words/images 12ₙ (and any other related intangible property asset data 12ₙ, etc.), of the same and/or all other required intangible property assets 16ₙ, would result in a state of the art intangible property asset 16ₙ search and verification system 10 which includes at its core a novel AI module(s) 26ₙ which is able to use intangible property asset data 12ₙ obtained from users 20ₙ (user 20ₙ data sources 14ₙ), and trusted and non-trusted third-party data sources or service providers 14ₙ, along with various image recognition processes/techniques and intelligence gained through deep machine learning, to create a robust, reliable, easy to use single reference to accurately establish the identity, history, ownership, and associated information, etc., of intangible property assets 16ₙ with a high degree of accuracy and thus provide information regarding the availability of intangible property asset 16ₙ for future use, protection, etc.

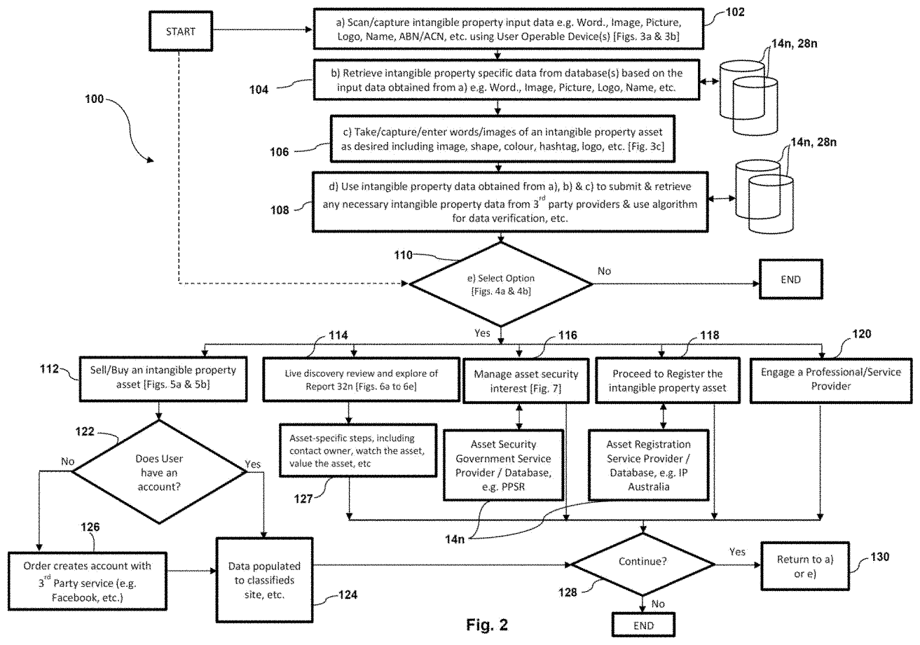

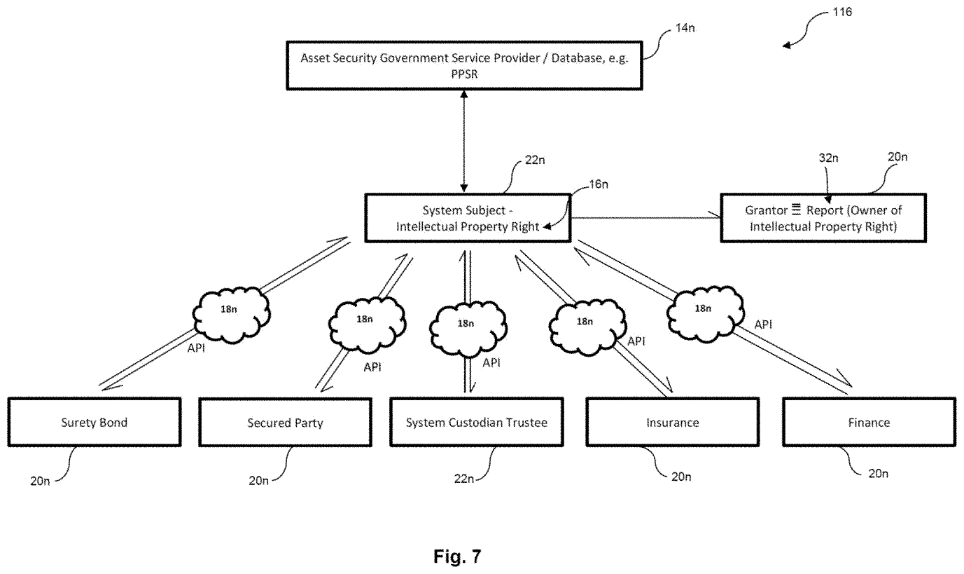

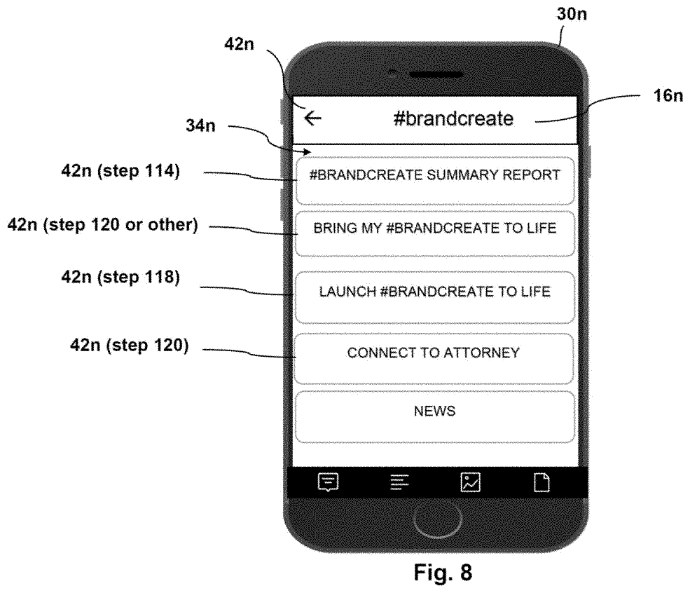

In order to provide a more detailed understanding of the operation of preferred system 10 of the present invention, and its many various preferred intangible property asset 16ₙ identification, verification and/or information display purposes, reference will now be made to the flow diagram of FIG. 2 which illustrates a preferred embodiment of an intangible property asset 16ₙ verification method 100 which is suitable for use with the preferred intangible property asset 16ₙ verification system 10 shown in FIG. 1. The preferred flow diagram of FIG. 2 (and hence, preferred intangible property asset 16ₙ verification method 100 of the present invention) will be described in conjunction with the exemplary GUI's 34ₙ shown in FIGS. 3a to 3c, 4a & 4b, 5a & 5b, and FIG. 8, along with the exemplary report(s) 32ₙ of FIGS. 6a to 6e, and block diagram of FIG. 7, each of which illustrate (mostly in steps) the preferred ways in which system 10 may be utilised by a user 20ₙ to perform the many various preferred intangible property asset 16ₙ search, identification, verification and/or information display purposes described herein. Although a preferred intangible property asset 16ₙ verification method 100 will be described with reference to the flow diagram of FIG. 2, and the exemplary GUI's 34ₙ, report(s) 32ₙ, and block diagram of FIGS. 3a to 8, it is to be understood that these diagrams only illustrate examples of the way in which intangible property asset data 12ₙ may be acquired, aggregated and analysed for intangible property asset 16ₙ verification purposes in accordance with the present invention. Many other methods (not shown) may be utilised to achieve the same or similar result and as such the present invention should not be construed as limited to the specific examples provided. Further, it will be appreciated by a skilled person that not all method steps are recited herein, and/or that some method steps that are recited herein are not essential to the operation of method 100. Various steps that are not recited, or which may be readily omitted or modified, will be readily apparent to a skilled person and thus need not be described in detail herein. Similarly, although exemplary GUI's 34ₙ are shown and described with reference to FIGS. 3a to 5b, and FIG. 8, it will be appreciated that any suitable GUI(s) 341 may be used depending on the application of system 10, and the way in which GUI(s) 34ₙ of system 10 are accessible via, for example, network(s) 18ₙ, to user(s) 20ₙ, via user operable devices 30ₙ. Further, the content of exemplary GUI's 34ₙ shown in FIGS. 3a to 5b, and FIG. 8, only represents an example of the type of information that may be displayed to user(s) 20ₙ of system 10. Accordingly, the present invention should not be construed as being limited to any or more of the specific GUI 341 examples provided herein.

In FIG. 2 there is shown a flow diagram which illustrates a preferred embodiment of an intangible property asset 16ₙ search and verification method 100 which is suitable for use with the preferred intangible property asset 16ₙ verification system 10 shown in FIG. 1. As can be seen in this figure, the preferred method 100 may commence at either step 102 or step 110, depending on whether or not a user 20ₙ has previously performed steps 102 to 108, as will now be described. Similarly, preferred method 100 may commence at step 110 if, for example, a user(s) 20ₙ simply wishes to purchase/sell an intangible property asset 16ₙ, or to engage a Professional/Service Provider in accordance with the present invention. Assuming a user 20ₙ has not previously used method 100 (or does not simply wish to go straight to the purchase/sell an intangible property asset 16ₙ option, i.e. step 112, of preferred method 100, or does not simply wish to go straight to the engage a Professional/Service Provider option, i.e. step 120, of preferred method 100), at step 102 it can be seen that method 100 preferably commences with a user(s) 20ₙ using their user operable device(s) 30ₙ (and any necessary user interface(s), e.g. external camera, smart glasses, smart watch, etc. (not shown), if required/desired) to enter, scan or otherwise capture initial intangible property asset input data 12ₙ, e.g. a particular of an intangible property asset's 16ₙ information, such as a word from a trade mark, a logo from a trade mark, a hashtag from an Instagram or Twitter handle, an object from a brand, an image, etc. As was already briefly described above, the initial intangible property asset input data 12ₙ may be acquired by a user(s) 20ₙ simply accessing and selecting previously captured image(s) 12ₙ (still or moving) of the selected intangible property asset 16ₙ which may have been previously stored on their user operable device(s) 30ₙ, or which may be accessible to the user operable device(s) 30ₙ via network 18ₙ (i.e. image(s) 12ₙ of the selected intangible property asset 16ₙ which may be readily available via the Internet 18ₙ, etc.), or may be acquired in real-time wherein a user(s) 20ₙ may point or hover, etc., their user operable device(s) 30ₙ at/over the selected intangible property asset 16ₙ (whether in person, in print, or on a screen, etc.) so that the user operable device(s) 30ₙ (using, e.g. an integral or coupled camera, etc.) may capture the required intangible property asset input data 12ₙ. It will be appreciated that at step 102, of preferred method 100, user operable device(s) 30ₙ may utilise the one or more preferred user operable device 30ₙ based module(s) or application(s) (not shown) described above with reference to (i), for capturing, transmitting, receiving, conveying and/or displaying intangible property asset data 12ₙ in accordance with preferred system 10. Thus, for example, the preferred OCR component/application, etc., of that preferred user operable device 30ₙ based module(s)/application(s) (i) may be utilised at step 102 to recognise, capture, convert and/or transmit intangible property asset 16ₙ identifier(s)/marker(s)/image(s) 12ₙ (not shown—but which may be, for example, the selected intangible property asset's 16ₙ information, such as image, shape, colour, logo, device of a brand, etc.) in the form of the initial intangible property asset input data 12ₙ. Exemplary GUI(s) 341 which illustrate a preferred way in which step 102, of preferred method 100, may be performed in real life are shown in FIGS. 3a & 3b. In this example, the GUI(s) 341 (and associated preferred module(s)/application(s) (i) (not shown), etc.) is/are installed on a smartphone device 30ₙ as shown, and the initial intangible property asset input data 12ₙ is being entered/scanned/captured by a user(s) 20ₙ pointing the smartphone's 30ₙ integral camera(s) (not shown) at the selected intangible property asset 16ₙ (which may be the actual intangible property asset 16ₙ, or an image 12ₙ thereof, etc.). In FIGS. 3a & 3b, it can be seen that preferred GUI(s) 34ₙ may include a nominated region or box 36 (along with user 20ₙ instructions 38, etc.) which may be aligned with the selected intangible property asset's 16ₙ identifier(s)/marker(s)/image(s) 12ₙ (e.g. word, picture or a logo, 12ₙ, etc.) such that OCR technology, etc., (of, for example, module(s)/application(s) (i) (not shown)) may then be used to recognise the target text/image and/or capture the identifier(s)/marker(s)/image(s) 12ₙ, which can then be used as the required initial intangible property asset input data 12ₙ in accordance with step 102, of preferred method 100, of the present invention. Whilst any suitable OCR technology may be utilised in accordance with step 102, of preferred method 100 (and preferred module(s)/application(s) (i) & (iii), etc., of system 10, as described hereinbefore), it has been found that OCR technology created/provided by companies such as, for example, Anyline GmbH (an Austrian company) or Sensor Dynamics Pty Ltd (an Australian proprietary limited company), is particularly well suited for intangible property asset 16ₙ purposes in accordance with the present invention.

After step 102, preferred method 100 continues at step 104, whereat the initial intangible property asset input data 12ₙ is utilised to retrieve further specific intangible property asset data 12ₙ from preferred third-party trusted and/or non-trusted data sources 14ₙ and/or preferred database(s)/storage device(s) 28ₙ (of network server 22ₙ). That is, method 100 utilises the initial intangible property asset input data 12ₙ acquired at step 102, to then retrieve or acquire (at step 104) further specific intangible property asset data 12ₙ that matches, or is associated with, or relates to, the initial intangible property asset input data 12ₙ, and hence, the selected intangible property asset 16ₙ itself. Whilst not specifically shown in the flow diagram of FIG. 2, it will be appreciated that at step 104, preferred method 100 may utilise module(s)/application(s) (ii) (not shown—but as was described above in detail), of system 10, in order to retrieve and/or acquire the required further specific intangible property asset data 12ₙ (from preferred third-party trusted and/or non-trusted data sources 14ₙ and/or preferred database(s)/storage device(s) 28ₙ).

Thereafter, at step 106, the user(s) 20ₙ is/are prompted or otherwise to take/enter/capture/provide a plurality of words/images 12ₙ of the selected intangible property asset 16ₙ (and particulars thereof, e.g. shape, colour, logo, etc.) at one or at different angles; including images 12ₙ that contain the selected intangible property asset's 16ₙ identifier(s)/images(s)/12ₙ (e.g. ABN/ACN numbers, object shapes, colours, domain names, logos, devices, hashtags, Twitter and/or Instagram handles, etc.). Exemplary GUI(s) 341 which illustrate a preferred way in which step 106, of preferred method 100, may be performed in real life are shown in FIG. 3c. Again, like in the case of the exemplary GUI(s) 34ₙ shown in FIGS. 3a & 3b, the exemplary GUI(s) 34ₙ (and associated preferred module(s)/application(s) (i) (not shown), etc.) of FIG. 3c is/are installed on a smartphone device 30ₙ as shown, and the images 12ₙ of the intangible property asset 16ₙ are being captured by a user(s) 20ₙ pointing the smartphone's 301 integral camera(s) (not shown) at the selected intangible property asset 16ₙ (which may be the actual intangible property asset 16ₙ, or a word or an image 12ₙ thereof, etc.). In FIG. 3c, it can be seen that preferred GUI(s) 34ₙ may include user 20ₙ instructions 38, etc., to prompt the user(s) 20ₙ to take/capture the required images 12ₙ at varying angles, and/or take images closer or further away from the object, and/or provide any further identifiers 12ₙ such as the colour of the object, information, etc., with the selected intangible property asset's 16ₙ identifier(s)/marker(s)/image(s) 12ₙ being visible in at least one of those words/images 12ₙ. Although not specifically shown in the flow diagram of FIG. 2, at step 106, preferred method 100 may utilise object detection and/or OCR technology, etc. (of, for example, module(s)/application(s) (i) and/or (iii) (not shown) described above) for analysing and recognising particulars (including, but not limited to: the shape/colour/image of an intangible property asset 16ₙ, its features, and/or its identifier(s)/marker(s)/image(s) 12ₙ, etc.) of the selected intangible property asset 16ₙ shown in the images 12ₙ (whether they be live, stored, still or moving images 12ₙ, etc.) captured and/or otherwise acquired at this step. OCR technology suitable for use at step 106, of preferred method 100 (and preferred module(s)/application(s) (i) & (iii), etc., of system 10, as described hereinbefore), if required/desired, has already been outlined above. Whilst any suitable object detection technology/processes may be utilised in accordance with step 106, of preferred method 100 (and preferred module(s)/application(s) (i) & (iii), etc., of system 10, as described hereinbefore), if required/desired, it has been found that object detection technology provided by Tensorflow (created by Google, Inc.) is particularly well suited for intangible property asset 16ₙ purposes in accordance with the present invention. Using the preferred Tensorflow object detection framework, preferred module(s)/application(s) 26ₙ (including preferred modules (i), (iii) and/or (iv) described above) of system 10, etc., are able to be trained to detect the boundaries and details of a specific intangible property asset 16ₙ shown in the captured/acquired words/images 12ₙ, which in conjunction with OCR technology (such as the OCR technology described hereinbefore), then enables the mechanical or electronic conversion of the words/images 12ₙ which contain typed, handwritten and/or printed text, into machine-encoded text which represents, for example, the selected intangible property asset's 16ₙ particulars, such as a word, name, number, picture 12ₙ, etc.

After step 106, preferred method 100 continues at step 108, whereat the intangible property asset data 12ₙ (including the plurality of words/images 12ₙ, etc.), for the selected intangible property asset 16ₙ, acquired throughout steps 102 to 106, is aggregated and stored in, for example, database(s)/storage device(s) 28ₙ, of network server 22ₙ, of system 10. That acquired/aggregated/stored intangible property asset data 12ₙ is then analysed, assessed and used to retrieve/acquire any further necessary intangible property asset data 12ₙ from trusted (e.g. from IP Australia, ASIC, the PPSR, etc.) and non-trusted (e.g. from Google, Facebook, Pinterest, Instagram, Twitter, Whois Domain Lookup, etc.) third-party data sources 14ₙ, and/or from database(s)/storage device(s) 28ₙ, of network server 22ₙ, using, for example, preferred module(s)/application(s) (ii) to (iv) (not shown—but as were described in detail hereinbefore) of system 10. When all necessary intangible property asset data 12ₙ, for the selected intangible property asset 16ₙ, has been acquired/captured, or as the necessary intangible property asset data 12ₙ is being continually obtained, or obtained as required (i.e. on demand, etc.), the preferred AI module(s) 26ₙ, of system 10, is/are preferably used at step 108 in order to, for example: analyse and verify the intangible property asset data 12ₙ (including acquired words/images 12ₙ) and/or the selected intangible property asset 16ₙ itself (and/or its associated information, such as ownership, related goods and/or services, etc., thereof); interpret any administrative nuances; and, filter out any extraneous information/data 12ₙ etc.; in order to collectively make ‘human like’ predictions about whether or not the selected intangible property asset 16ₙ is available for use, registration and/or protection in accordance with the present invention.

As can be seen in the flow diagram of FIG. 2, after steps 102 through to 108 have been performed/completed, preferred method 100 of the present invention then enables a user(s) 20ₙ, at decision step 110, to select one or more of a number of preferred intangible property asset 16ₙ identification, verification and/or information display options/features that may be performed/utilised in accordance with the present invention. If at decision step 110, a user(s) 20ₙ does not wish, or fails, to select an available option, then preferred method 100 may simply end, as shown in FIG. 2, or may loop back or stall (not shown) as necessary awaiting a user(s) 20ₙ command. Alternatively, at decision step 110, a user(s) 20ₙ may opt to select from the one or more preferred options/features as shown in FIG. 2. Those preferred options/features including, but not limited to: (step 112) sell/buy an intangible property asset 16ₙ; (step 114) conduct a live discovery review and explore a report(s) 32ₙ using live or real-time discovery of an intangible property asset 16ₙ and/or features/specifications/information, etc., thereof; (step 116) record or manage an intangible property asset 16ₙ security interest; (step 118) proceed to register an intangible property asset 16ₙ with a governing body(ies), etc.; and/or, (step 120) engage an intellectual property industry professional or a service provider (such as a Trade Marks Attorney, a graphic designer, a photographer, or a marketing specialist—not shown) to assist with further matters associated with a selected intangible property asset 16ₙ. Using the preferred report(s) 32ₙ, an intellectual property industry professional or a service provider (not shown) may then assist with filing and/or registration or protection of an intangible property asset 16ₙ—if it is a registrable/protectable intangible property asset 16ₙ, such as, for example, an intellectual property right or a domain name, etc. — or may use the preferred report(s) 32ₙ to, for example: assess the likelihood of an infringement; use it as a basis for seeking consent to the use of an intangible property asset 16ₙ; and/or, lodge an application for revocation of a trade mark for non-use, etc. Furthermore, the preferred report(s) 32ₙ could also preferably be used as a basis for licensing and/or franchising opportunities, etc. Although specific intangible property asset 16ₙ embodiments/options, etc., are shown and described herein with reference to FIGS. 2 to 8, it should be appreciated that the present invention is not limited to that use, or those examples, only.

Exemplary GUI(s) 341 which illustrate a preferred way in which each of the preferred options/features (i.e., steps 112 to 120) of preferred method 100 may be accessed at decision step 110, are shown in FIGS. 4a & 4b. Again, like in the case of the exemplary GUI(s) 34ₙ shown in FIGS. 3a to 3c, the exemplary GUI(s) 34ₙ of FIGS. 4a & 4b is/are installed on a smartphone device 30ₙ as shown. In FIG. 4a, the GUI(s) 34ₙ is in a preferred state (at decision step 110) after each of steps 102 through to 108 have been completed. Here it can be seen that aside from showing images/information 12ₙ about the selected intangible property asset 16ₙ, which may be toggled or scrolled through by way of navigation region 40, etc., exemplary GUI(s) 341 may also provide a number of preferred buttons or navigation region(s) 42ₙ (collectively referred to as “button(s) 42ₙ”) which may enable various preferred features and/or screens of exemplary GUI(s) 341 to be accessed/viewed, etc., as desired/required. For example, a series of button(s) 42ₙ may be provided along the bottom of GUI(s) 34ₙ, as shown, to enable a user(s) 20ₙ to access and/or view, for example, various preferred trade mark related data and/or features 44ₙ, etc., related to the selected intangible property asset 16ₙ (wherein, in the example of FIG. 4a, the intangible property asset 16ₙ is a trade mark) and/or system 10, such as, for example: a forum/chat and/or AI robot help desk assistant 45; a button 46 which a user(s) 20ₙ can selectively utilise to access an intangible property asset 16ₙ status report page(s), for viewing or requesting intangible property asset data 12ₙ reports 32ₙ (such as, for example, a trade mark status report, or validation reports 32ₙ, transaction reports/receipts 32ₙ, etc., as shown and described with reference to system 10, of FIG. 1); a related information page 47 concerning intangible property assets 16ₙ; and/or, a page or assistant 48 for enabling a user(s) 20 to, for example, selectively upload or otherwise capture/store, selective intangible property asset 16ₙ associated information, such as history, notes, etc. 12ₙ (in the case of a trade mark, this could be information relating to an assignment and/or particulars of the goods/services, etc.). Also, preferably provided is a separate button(s) 42ₙ (for example, an ‘Explore Your Trade Mark No.: 12345 button(s) 42ₙ in the embodiment shown in FIG. 4a) for accessing the further preferred GUI(s) 34ₙ screen shown in FIG. 4b, which GUI(s) 34ₙ screen provides/presents a user(s) 20ₙ with a series of navigation regions or button(s) 42ₙ that the user(s) 20ₙ may opt to use to selectively access/utilise the preferred options/features (i.e. steps 112 to 120) of preferred method 100 of the present invention. Referring to FIG. 4b, it can be seen that exemplary GUI(s) 34ₙ preferably includes a separate region(s)/button(s) 42ₙ for accessing/utilising each of steps 112 to 120 (and their associated options/features, etc.) of preferred method 100 of the present invention. Finally, the exemplary GUI(s) 341 of both FIGS. 4a and 4b may also preferably provide user 20ₙ instructions and/or intangible property asset 16ₙ details, in the form of a dedicated area(s) of region(s) 38 of GUI(s) 34ₙ, as shown. Whist specific intangible property asset 16ₙ information/data 12ₙ, and button(s) 42ₙ and region(s) 38 (and associated features, etc., e.g. features 45 to 48, etc.) are shown and described herein as being visible/accessible/usable within the exemplary GUI(s) 34ₙ of FIGS. 4a & 4b, it should be appreciated that the present invention is not limited to the specific examples provided.

If a user(s) 20ₙ opts to select the ‘sell/buy an intangible asset 16ₙ’ option, i.e. step 112, of preferred method 100 (using, e.g. the applicable button(s) 42ₙ, i.e. “Sell Your Trade Mark” in this embodiment, shown in the exemplary GUI(s) 34ₙ of FIG. 4b), then method 100 continues at decision step 122, whereat a check is preferably made (either automatically, or upon instruction from user(s) 20ₙ, etc.) to see whether the user(s) 20ₙ has a user account with the applicable intangible classifieds business, auctioneer, etc. (e.g. Gumtree, Facebook, Twitter, etc. — hereinafter, collectively referred to as “sales site(s)”)—i.e. whether the specific user(s) 20ₙ is authorised to list the selected intangible property asset 16ₙ for sale via the chosen and/or predetermined sales site(s). If at decision step 122 it is determined that the user(s) 20ₙ does have an account with the chosen and/or predetermined sales site(s), then method 100 continues at step 124, whereat any available previously verified (e.g. at step 108, of preferred method 100, using, for example, AI module(s) 26ₙ of network server 22ₙ, of system 10) intangible property asset data 12ₙ necessary for listing the selected intangible property asset 16ₙ for sale via that sales site(s) is automatically populated/provided to that sales site(s). Alternatively, if at decision step 122 it is determined that the user(s) 20ₙ does not have an account with the chosen and/or predetermined sales site(s), then method 100 continues at step 126, whereat the user(s) 20ₙ may be prompted to create a user account with the chosen and/or predetermined sales site(s), or method 100 may in itself automatically create the necessary user account on behalf of the user(s) 20ₙ as shown. Thereafter, preferred method 100 continues as before at step 124, whereat any available previously verified intangible property asset data 12ₙ necessary for listing the selected intangible property asset 16ₙ for sale via that sales site(s) is automatically populated/provided to that sales site(s). Although not shown in the flow diagram of FIG. 2, at either of steps 112 or 124, the preferred method 100 may prompt and/or otherwise enable a user(s) 20ₙ to manually add some additional predetermined intangible property asset data 12ₙ, such as, for example, the intangible property asset's 16ₙ sale price, goods or services traded 12ₙ, etc., to the sales site(s) listing for the selected intangible property asset 16ₙ. Method 100 then continues at decision step 128, whereat if the user(s) 20ₙ wishes to finish using method 100, or fails to select an option, preferred method may simply end, as shown in FIG. 2, or may loop back or stall (not shown) as necessary awaiting a user(s) 20ₙ command. Alternatively, at decision step 128 a user(s) 20ₙ may elect (at step 130) to return to either the start of method 100 (e.g. step 102, whereat the user 20 may choose to capture, search, and verify, etc., intangible property asset data 12ₙ concerning a different intangible property asset 16ₙ), or to decision step 110 of method 100, whereat user(s) 20ₙ may choose to utilise any one of preferred options/features 112 to 120 as herein described.

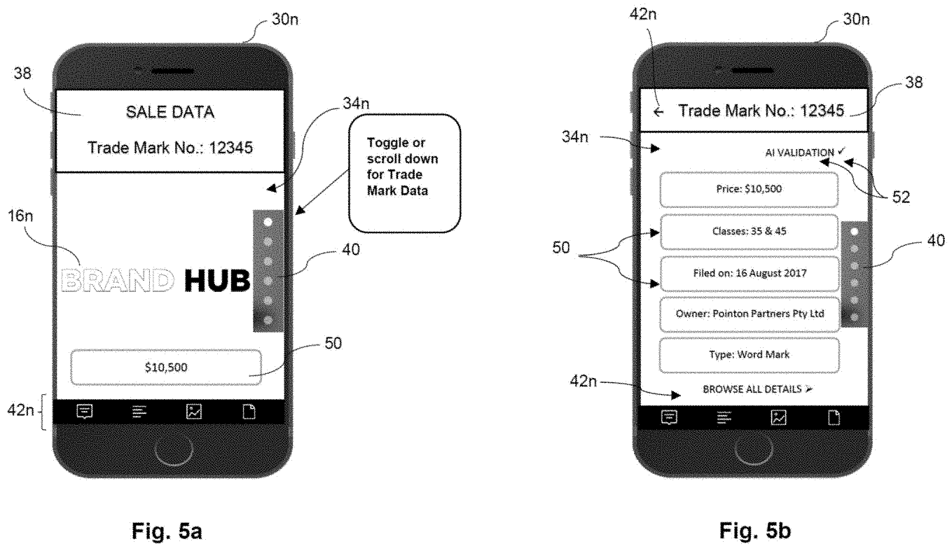

Exemplary GUI(s) 34ₙ which illustrate an example of the sort of intangible property asset data 12ₙ that may be displayed/accessed to/by a user(s) 20ₙ at the ‘sell/buy an intangible property asset 16ₙ’ option, i.e. step 112, of preferred method 100, are shown in FIGS. 5a & 5b. Again, like in the case of the exemplary GUI(s) 34ₙ shown in FIGS. 3a to 4b, the exemplary GUI(s) 341 (and any associated preferred module(s)/application(s), such as, for example, module(s) (i)—not shown, but as was discussed in detail above) of FIGS. 5a and 5b is/are installed on a smartphone device 30ₙ as shown. In FIG. 5a, it can be seen that exemplary GUI(s) 34ₙ may preferably show/provide one or more words/images 12ₙ of the selected intangible property asset 16ₙ, along with any necessary instructions 38 or associated data 12ₙ. Referring now to both FIGS. 5a & 5b, it can be seen that exemplary GUI(s) 34ₙ may also preferably include one or more field(s) or region(s) 50, such as, for example, a sale price field 50, as shown in both FIGS. 5a & 5b, or trade mark classes or filing date field(s) 50, as shown in FIG. 5b, which may either be automatically populated by system 10 (i.e. based on, for example, an AI valuation of the selected intangible asset 16ₙ, or by being detected in one or more image(s) 12ₙ of the selected intangible property asset 16ₙ, etc.), or which may be populated by a user(s) 20ₙ, as desired (e.g. with or without the need to override any system 10 generated sales price, and other particulars, 12ₙ etc.). In FIG. 5b, it can be seen that further pages/screens of exemplary GUI(s) 34ₙ may also preferably be accessed/provided to user(s) 20ₙ at or during step 112 (and associated steps), of preferred method 100, of the present invention. As is shown in this figure, it is preferred that the intangible property asset data 12ₙ displayed within those preferred GUI(s) 34ₙ is able to be toggled or scrolled, etc., by way of navigation region(s) 40 or button(s) 42ₙ. Within the exemplary GUI(s) 341 shown in FIG. 5b, it can be seen that various intangible property asset data 12ₙ for the selected intangible property asset 16ₙ, including the filing date, ownership details, classes, and other particulars 12ₙ, etc., has been automatically populated on those pages (which are preferably pages of one or more chosen and/or predetermined sales site(s)) such that the selected intangible property asset 16ₙ may be, or has been, listed for sale via the chosen and/or predetermined sales site(s). In addition, and importantly, in the exemplary GUI(s) 34ₙ of FIG. 5b, it is preferred that some form of marking(s), badge(s), shield(s), and/or indicia 52, etc., is clearly shown or otherwise provided to indicate that at least the important intangible property asset data 12ₙ (including one or more words/images 12ₙ of the selected intangible property asset 16ₙ) displayed/presented within GUI(s) 34ₙ has been searched, analysed and verified (at step 108, of preferred method 100) as being true and correct by way of AI module(s) 26ₙ, etc., of system 10.

Although not shown in the flow diagram of FIG. 2, or shown or described with reference to the exemplary GUI(s) 34ₙ of FIGS. 5a and 5b, it will be appreciated that various forms of intangible property asset data 12ₙ related report(s), receipt(s), etc. 32ₙ, such as, for example, intangible property asset data 12ₙ validation report(s) 32ₙ, etc., as shown and described with reference to system 10, of FIG. 1, may be requested and/or otherwise provided to user(s) 20ₙ as part of the ‘sell/buy an intangible property asset 16ₙ’ option, i.e. step 112, and associated steps, of preferred method 100, of the present invention.

Accordingly, it should be appreciated that each of FIG. 2 and FIGS. 5a and 5b, clearly illustrate that preferred system 10 and/or method 100 of the present invention, readily provides an automated process(es) for capturing, analysing, verifying and/or displaying intangible property asset data 12ₙ for the purpose of listing a selected intangible property asset 16ₙ for sale or purchase via one or more chosen and/or predetermined sales site(s), etc. Such an automated process(es) provides many benefits in terms of selling/buying an intangible property asset 16ₙ, including, but not limited to: business owner's (user(s) 20ₙ) having the ability to check the availability of a business name for purchasing of intangible property asset(s) 16ₙ and if available, can proceed to contact the owner of that asset 16ₙ. The advantages of this method include provision of an established history of the asset 16ₙ, etc.; specifications and related information of an intangible property asset 16ₙ can easily be provided/displayed to a buyer and/or business owner (user(s) 20ₙ); peace of mind that the intangible property asset data 12ₙ acquired from the seller (user 20ₙ) of an intangible property asset 161 has been validated and verified as true and correct, etc.; quick access to intangible property asset data 12ₙ; ‘click and view’ of related details, specifications and information/data 12ₙ concerning intangible property assets 16ₙ; trust transparency between buyers (user(s) 20ₙ) and sellers (user(s) 20ₙ); display of intangible property asset data 12ₙ to consumers (and user(s) 20ₙ) in a detailed and simplified format; verification of information/data 12ₙ presented from relevant authorities (i.e. trusted and non-trusted data sources 14ₙ); and/or, ability to automatically obtain intangible property asset data 12ₙ via a photo, video, etc. (i.e. images 12ₙ), and from one or more intangible property asset 16ₙ identifier(s)/marker(s)/images(s) 12ₙ (e.g. business name, trade mark, logo, picture, etc.). Whilst such an automated process(es) also overcomes known problems associated with the sale of an intangible property asset 16ₙ, including, but not limited to: multiple ways to obtain intangible property asset data 12ₙ from data sources 14ₙ such as, for example, IP Australia, PPSR, ASIC, LinkedIn, Facebook, etc.; consumers (user(s) 20) needing to seek out intangible property asset information/data 12ₙ from various data sources 14ₙ—where the provided data 12ₙ may not be accurate, etc.; difficulties associated with determining an intangible property asset's 16ₙ availability, including part or whole trade mark availability and/or similarity to the existing trademarks, etc.; time and money wasted in searching for intangible property asset data 12ₙ for a specific intangible property asset 16ₙ; intangible property asset 16ₙ owners (user(s) 20ₙ) being unable to adequately or efficiently register their intangible property assets 16ₙ; intangible property asset data 12ₙ entry and access problems and/or errors; and/or, lack of (or difficulties associated with) integration with third-party data sources 141.

If a user(s) 20 opts to select the ‘live discovery review and explore of report 32ₙ’ option, following step 110, of preferred method 100 (using, e.g. the applicable ‘Live Discovery Review’ button(s) 42ₙ shown in the exemplary GUI(s) 34ₙ of FIG. 4b), then method 100 continues at step 114, whereat a user(s) 20ₙ may selectively and interactively explore, browse, research, review, etc., intangible property asset data 12ₙ associated with one or more retrieved intangible property assets 16ₙ and/or their particulars, features, specifications, similar assets, etc., thereof, as will be described in further detail below with reference to FIGS. 6a to 6e. After a user(s) 20ₙ is finished exploring, researching, etc., desired intangible property asset data 12ₙ associated with one or more selected intangible property asset(s) 16ₙ, method 100 then continues at decision step 128, as before described, whereat if the user(s) 20ₙ wishes to finish using method 100, or fails to select an option, etc., preferred method 100 may simply end, loop back, stall, etc., or may return (at step 130) to either step 102 or decision step 110 of method 100, as herein described, should the user(s) 20ₙ wish to continue using method 100.

FIGS. 6a to 6e illustrate examples of a preferred report(s) 32ₙ which a user(s) 20ₙ may explore, research, browse etc., for intangible property asset data/images/features, etc. 12ₙ, of a selected intangible property asset(s) 16ₙ in accordance with the ‘live discovery review and explore of report 32ₙ’ of an intangible property asset 16ₙ option, i.e., step 114, of preferred method 100. In FIGS. 6a to 6e, a preferred embodiment of a report(s) 32ₙ showing how a user(s) 20ₙ may explore, research, etc., the features, etc. 12ₙ of a selected intangible property asset 16ₙ is illustrated, which in this embodiment, is preferably depicted on a screen (not shown), etc., of a user operable device(s) 30ₙ, e.g., a smartphone 30ₙ. In this example, a user 20ₙ has enquired about the availability of an intangible property asset 16ₙ in the form of a brand name “BrandHub” in New Zealand and entered the word “BrandHub” at step 102 followed by entering letters “NZ” at step 106. As can be seen in FIGS. 6a to 6e, preferred method 100 has then produced a report(s) 32ₙ showing the availability of the selected brand name (i.e., intangible property asset 16ₙ) and associated information from the following preferred platforms (i.e., third party data sources 14ₙ): Instagram, Facebook, IP Australia, ASIC, and, a domain name registry Whois search provider. In an alternative preferred embodiment (not shown), a user(s) 20ₙ may explore, research, hover over and view two-dimensional and three-dimensional shapes, etc., the features, etc. 12ₙ of a selected intangible property asset 16ₙ using a preferred augmented reality environment which may be created in accordance with system 10 and/or method 100 of the present invention. Whilst any suitable augmented reality technology/techniques may be utilised in accordance with step 114, of preferred method 100, of the present invention, it has been found that augmented reality technology known as Vuforia (developed by PTC, a United States corporation) is particularly well suited for use with intangible property assets 16ₙ in accordance with the present invention.

In embodiments shown in FIGS. 6a to 6e, it can be seen that at step 114, of preferred method 100, the GUI(s) (and associated module(s)/application(s) (i) (not shown)) are preferably configured/designed to recognise (using object detection, OCR and AI technology, etc., as hereinbefore described) the selected intangible property asset 16ₙ (whether a word(s)/image(s) 12ₙ of the intangible property asset 16ₙ and/or a live or real-time capture of the intangible property asset 16ₙ) and to then overlay (or otherwise) that intangible property asset 16ₙ with selectable region(s), button(s), text and/or animations, etc. (collectively referred to hereinafter as “informative object(s) 54ₙ”) which can then be viewed, selected, hovered-over, etc., by a user(s) 20ₙ, as desired within report(s) 32ₙ, so as to enable the user(s) 20ₙ to readily explore, etc., and learn about the various features, etc. 12ₙ, and associated intangible property asset 16ₙ. The exploration of a report(s) 32ₙ may allow a user 20ₙ (at step 127) to view an intangible property asset 16ₙ and or its features 12ₙ, and/or to perform any, but not limited to the following, actions: to follow the business/Instagram handle/Twitter handle/Pinterest handle, to contact the owner for general information, to contact the owner for asset-specific information, such as for example to acquire, seek permission, license, franchise the use of the intangible property asset 16ₙ, and/or contact the business, to watch the intangible property asset 16ₙ for status updates (for example if it is a Trade Mark Application, or Instagram handle), to seek a valuation of the intangible property asset 16ₙ, to view Trade Mark status reports, to view company registration and associated details, etc.

Although not shown in the flow diagram of FIG. 2, or shown or described with reference to FIGS. 6a to 6e, it will be appreciated that various forms of intangible property asset data 12ₙ related report(s), etc. 32ₙ, such as, for example, intangible property asset 16ₙ validation reports 32ₙ, transaction reports/receipts 32ₙ, etc., as shown and described with reference to system 10, of FIG. 1, may be requested and/or otherwise provided to user(s) 20ₙ as part of the ‘live discovery review and explore of report 32ₙ’ option, i.e. step 114, of preferred method 100, of the present invention.

Accordingly, it should be appreciated that each of FIG. 2 and FIGS. 6a to 6e, clearly illustrate that preferred system 10 and/or method 100 of the present invention, readily provides an automated process(es) which may be utilised by a user(s) 20ₙ to selectively and interactively explore, research, review, etc., intangible property asset data 12ₙ concerning one or more selected intangible property assets 16ₙ and/or its related information 12ₙ. Such an automated process(es) provides many benefits in terms of exploring or researching, etc., the features, etc. 12ₙ of an intangible property asset 16ₙ, including, but not limited to: easy one-place reference, quick access to intangible property asset data 12ₙ; ‘click and view’ of ownership details and other associated information/data 12ₙ concerning intangible property assets 16ₙ; utilisation of artificial intelligence and related technology (e.g. module(s)/application(s) (ii) to (iv) as described hereinbefore, including, importantly, AI module(s) 26ₙ) which collates/aggregates data 12ₙ from various relevant authorities 14ₙ which are licenced to hold such information 12ₙ; display of intangible property asset data 12ₙ to user(s) 20ₙ in a detailed and simplified format; and/or, verification and providing information on the availability for use of an intangible property asset 16ₙ or data/information 12ₙ prior to (or during) display/provision to a user(s) 20ₙ. Whilst such an automated process(es) also overcomes known problems associated with the existing techniques for exploring and/or researching, etc., intangible property asset data 12ₙ or intangible property assets 16ₙ, including, but not limited to: multiple ways to obtain intangible property asset data 12ₙ from data sources 14ₙ such as, for example, IP Australia, PPSR, ASIC, Facebook, Twitter, etc.; consumers (user(s) 20ₙ) needing to seek out intangible property asset information/data 12ₙ from various data sources 14ₙ—where provided data 12ₙ may not be accurate, etc.; difficulties associated with determining an intangible property asset's 16ₙ similarity and/or availability, paying multiple fees for obtaining required information, etc.; time and money wasted in searching for intangible property asset data 12ₙ for a specific intangible property asset 16ₙ; comparing results from multiple sources, making an assessment whether the proposed/searched for intangible property asset 16ₙ is identical or similar to an intangible property asset 16ₙ provided as a result of the search and verification method; intangible property asset data 12ₙ entry and access problems and/or errors; and/or, lack of (or difficulties associated with) integration with third-party data sources 141.

If a user(s) 20 opts to select the ‘manage asset security interest’ option, i.e. following step 110, of preferred method 100 (using, e.g. the applicable ‘Asset Security Interest’ button(s) 42ₙ shown in the exemplary GUI(s) 34ₙ of FIG. 4b), then method 100 continues at step 116, whereat a user(s) 20ₙ may selectively record, modify, remove, etc., an intangible property asset 16ₙ security interest, as will be described in further detail below with reference to exemplary block diagram of FIG. 7. After a user(s) 20ₙ is finished recording, modifying, removing, etc., a desired/required intangible property asset 16ₙ security interest, method 100 then continues at decision step 128, as before described, whereat if the user(s) 20ₙ wishes to finish using method 100, or fails to select an option, etc., preferred method 100 may simply end, loop back, stall, etc., or may return (at step 130) to either step 102 or decision step 110 of method 100, as herein described, should the user(s) 20ₙ wish to continue using method 100.

An exemplary block diagram which illustrates examples of the way in which various user(s) 20ₙ may record, modify, remove, etc., intangible property asset 16ₙ security interest(s) in accordance the ‘manage asset security interest’ option, i.e. step 116, of preferred method 100, is shown in FIG. 7. In this figure it can be seen that any of a variety of parties (all collectively referred to as “user(s) 20ₙ”) that may be involved in an intangible property asset 16ₙ security interest(s), such as, for example: intangible property asset 16ₙ owner(s) 20ₙ; finance providers 20ₙ (e.g. banks, credit agencies, etc.); insurance companies 20ₙ; secured parties 20ₙ (e.g. private lenders, etc.); and/or, surety bond providers or other forms of guarantors, etc. 20ₙ; may selectively utilise the system 10 and/or method 100 of the present invention, as required/desired, in to record, modify, remove, etc., an intangible property asset 16ₙ security interest(s) with the applicable trusted third-party service provider(s) 14ₙ, such as, for example, the PPSR as shown, without the need to interact directly with the/that third-party service provider(s) 14ₙ. That is, network server 22ₙ, of system 10, is also preferably configured to act as an intermediary between the various parties (user(s) 20ₙ) of an intangible property asset 16ₙ security interest(s) and the appointed government agency(ies) or service provider(s) 14ₙ (which in the case of Australia, is the PPSR) that are responsible for maintaining security interests or caveats concerning intangible property assets 16ₙ, etc. In this way, system 10 and/or method 100 of the present invention, including importantly its AI module(s) 26ₙ, etc., provides a novel and important means of, for example, preventing fraud, whilst automatically maintaining recorded security interest(s) integrity, etc.

Additionally, and as can also be seen in FIG. 7, aside from readily enabling the various concerned parties (user(s) 20ₙ) themselves to record, modify, remove, etc., any desired or necessary intangible property asset 16ₙ security interest(s), at step 116, of preferred method 100, system 10 may also preferably provide a service wherein it (i.e. the administrator(s) or provider(s) of system 10) acts as a custodian trustee (“system custodian trust 22ₙ”), wherein the system custodian trustee 22ₙ may register, modify, remove, etc., security interest(s) on behalf of, for example, the owner (user(s) 20ₙ) of an intangible property asset(s) 16ₙ, or the finance provider or lender 20ₙ, etc. Alternatively, another party (user(s) 20ₙ), such as, for example, InfoTrack (an Australian company), may act as a custodian trustee on behalf of system 10, and may register, modify, remove, intangible property asset 16ₙ security interest(s) on behalf of others (including user(s) 20ₙ). In both of these preferred embodiments, the administrator(s)/provider(s) of system 10 (not shown), or the other party (e.g., InfoTrack, etc.) 20ₙ, may hold any necessary surety bond(s), guarantees, etc., as required in accordance with typical security interest records.

Although not specifically shown in the flow diagram of FIG. 2, but as can be seen in the exemplary block diagram of FIG. 7, and as is shown and described with reference to system 10, of FIG. 1, it will be appreciated that various forms of report(s), receipt(s), etc. 32ₙ, such as, for example, PPSR report(s) 32ₙ and related transaction receipt(s) 32ₙ, etc., may be requested and/or otherwise provided to user(s) 20ₙ as part of the ‘manage asset security interest’ option, i.e. step 116, of preferred method 100, of the present invention.

Accordingly, it should be appreciated that each of FIGS. 2 & 7, clearly illustrate that preferred system 10 and/or method 100 of the present invention, readily provides an automated process(es) which may be utilised by user(s) 20ₙ to selectively record, modify, etc., intangible property asset 16ₙ security interest(s) as desired/required. Such an automated process(es) provides many benefits in terms of the recordal or modification, etc., of security interests, including, but not limited to: piece of mind for intangible property asset 16ₙ owners (user(s) 20ₙ); quick access to intangible property asset data 12ₙ associated with the security interest, etc.; utilisation of artificial intelligence and related technology (e.g. module(s)/application(s) (ii) to (iv) as described hereinbefore, including, importantly, AI module(s) 26ₙ) which collates/aggregates data 12ₙ from various relevant authorities 14ₙ which are licenced to hold such information 12ₙ; providing information regarding any security interest on an intangible property asset 16ₙ to a delegate of an Intellectual Property Office when there is a need to record an assignment and/or change of ownership of an intellectual property asset 16ₙ; display of intangible property asset data 12ₙ to user(s) 20ₙ in a detailed and simplified format; verification of the intangible property asset data/information 12ₙ prior to (or during) security interest recordal, modification, etc., and/or display/provision to a user(s) 20ₙ; and/or, provides a means to prevent fraud and to automatically maintain recorded security interest(s) integrity, etc. Whilst such an automated process(es) also overcomes known problems associated with the existing techniques in terms of the recordal or modification, etc., of security interests, including, but not limited to: time and money wasted in searching for intangible property asset data 12ₙ for a specific intangible property asset 16ₙ; intangible property asset data 12ₙ entry and access problems and/or errors; and/or, lack of (or difficulties associated with) integration with third-party data sources 14ₙ.

If a user(s) 20 opts to select the ‘Proceed to Register the intangible property asset” 16ₙ option, i.e. following step 110, of preferred method 100 (using, e.g. the applicable button(s) 42ₙ, i.e. “Register a Domain Name” in the embodiment shown in the exemplary GUI(s) 34ₙ of FIG. 4b), then method 100 continues at step 118, whereat a user(s) 20ₙ may selectively opt for any of the following options, including, but not limited to the following: contact a corresponding governing authority, such as IP Australia to file an application for a Trade Mark; file a Trade Mark Application directly with IP Australia; utilise IP Australia's assisted trade mark filing service (known as their “Trade Mark HeadStart” service); register a company or business name with ASIC and/or other relevant authority; register a domain name; and/or, register an Instagram/Twitter/Pinterest handle; etc. After a user(s) 20ₙ is finished registering one or more selected intangible property asset(s) 16ₙ, etc., method 100 then continues at decision step 128, as before described, whereat if the user(s) 20ₙ wishes to finish using method 100, or fails to select an option, etc., preferred method 100 may simply end, loop back, stall, etc., or may return (at step 130) to either step 102 or decision step 110 of method 100, as herein described, should the user(s) 20ₙ wish to continue using method 100.

If a user(s) 20ₙ opts to select the ‘Engage a Professional/Service Provider” option, i.e. following step 110, of preferred method 100 (using, e.g. the applicable “Contact Professional Service Provider’ button(s) 42ₙ shown in the exemplary GUI(s) 34ₙ of FIG. 4b), then method 100 continues at step 120, whereat a user(s) 20ₙ may be directed to the following options, including, but not limited: engage an intellectual property industry professional or a service provider (such as a Trade Marks Attorney, a graphic designer, a photographer, or a marketing specialist—not shown) to assist with further matters associated with a selected intangible property asset 16ₙ. Using the preferred report(s) 32ₙ, generated by system 10 and/or method 100 of the present invention, an intellectual property industry professional or a service provider (not shown) may then assist with filing and/or registration or protection of an intangible property asset 16ₙ—if it is a registrable\protectable intangible property asset 16ₙ, such as, for example, an intellectual property right or a domain name, etc. — or may use the preferred report(s) 32ₙ to, for example: assess the likelihood of an infringement; use it as a basis for seeking consent to the use of an intangible property asset 16ₙ; and/or, lodge an application for revocation of a trade mark for non-use, etc. Furthermore, these professionals or service providers may provide assistance with the following: the launch of a new brand, the preparation of a new logo, creation and/or preparation of text and/or pictures for social media and/or catalogues, etc.

Although not specifically shown in the flow diagram of FIG. 2, but as can be seen in FIG. 8, and as is shown and described with reference to system 10, of FIG. 1, it will be appreciated that various forms of screen(s)/page(s), report(s), receipt(s), etc. 32ₙ, may be requested and/or otherwise provided to user(s) 20ₙ as part of step 110 (or other steps), of preferred method 100, shown in FIG. 2. As can be seen in FIG. 8, that exemplary screen(s)/page(s)/report(s) 32ₙ, may contain feature(s) 12ₙ of the intangible property asset 16ₙ, and options 42ₙ available to the user, that must be selected for proceeding with for example, accessing a summary report for the intangible property 16ₙ for particulars and asset data 12ₙ and/or selecting an option of personalising and/or producing an intangible property asset 16ₙ (such as a brand, in this specific case, where a name of the brand is # brandcreate), and/or if the user(s) 20ₙ is content with launching their brand, then they can select the ‘launch’ option. This option would proceed to similar options as those for ‘Proceed to Register an intangible property asset’ 16ₙ as described above and would connect the user to authorities that enable the registration (such as IP Australia, ASIC, Instagram, Twitter or other websites), etc.

Accordingly, it should be appreciated that each of FIG. 1 to FIG. 8, clearly illustrate that preferred system 10 and/or method 100 of the present invention, readily provides an automated process(es) which may be utilised by a user(s) 20 to acquire information regarding intangible property asset 16ₙ and predict its availability for use, etc. Such an automated process(es) provides many benefits in terms of predicting availability of an intangible property asset 16ₙ, etc., including, but not limited to: quick access to intangible property asset data 12ₙ; utilisation of artificial intelligence and related technology (e.g. module(s)/application(s) (ii) to (iv) as described hereinbefore, including, importantly, AI module(s) 26ₙ) which collates/aggregates data 12ₙ from various relevant authorities 14ₙ which are licenced to hold such information 12ₙ; display of intangible property asset data 12ₙ to user(s) 20ₙ in a detailed and simplified format; ability for industry personnel (user(s) 20ₙ) to utilise the automated process(es) to assess at least the availability of intangible property asset 16ₙ for use, to build, personalise, protect and register intangible property assets 16ₙ; verification of the intangible property asset(s) 16ₙ and/or data/information 12ₙ prior to (or during) the registration/protection of same; and/or, integration with third-party parts suppliers or authorities enabling quick access to registration/protection and/or launching of an intangible property asset 16ₙ, etc. Whilst such an automated process(es) also overcomes known problems associated with the existing techniques/processes for acquiring/retrieving intangible property asset 16ₙ information, etc., including, but not limited to: laborious and time consuming mostly manual processes which often lead to inaccurate information, etc.; intangible property asset data 12ₙ entry and access problems and/or errors; lack of (or difficulties associated with) integration with third-party data sources 14ₙ; the need to know the availability of a specific intangible property asset 16ₙ and the need to avoid infringement of other intangible property assets 16ₙ.

The present invention therefore provides a novel and useful asset verification system 10 and/or method 100 which is particularly well suited for acquiring, aggregating and analysing intangible property asset data 12ₙ from multiple data sources 14ₙ for various intangible property asset 16ₙ identification, verification and/or information display purposes. Many advantages of the present invention will be apparent from the detailed description of the preferred embodiments provided hereinbefore. Examples of those advantages include, but are not limited to: the provision of a robust, reliable and easy to use single reference for intangible property asset 16ₙ information 12ₙ which can readily be used to verify the history, authenticity, etc., of intangible property assets 16ₙ with a high degree of accuracy; the ability to differentiate between correct and incorrect (or fraudulent), as well as related and un-related data 12ₙ, interpret administration nuances, filter out extraneous information/data 12ₙ and/or make ‘human like’ predictions about the availability of intangible property assets 16ₙ; the provision of an automated system 10 which streamlines the entire process of collating intangible property asset data 12ₙ (and any associated data/information) from multiple data sources 141, whilst eliminating arduous paperwork, multiple databases/sources 14ₙ, manual input errors and lengthy wait times, etc.; and/or, the provision of an automated system 10 that enables a user(s) 20ₙ to simply point/hover their user operable device(s) 30ₙ (with or without any accessories) at/over a selected intangible property asset 16ₙ and its identifier(s)/marker(s)/image(s) 12ₙ (e.g. registration numbers, ABN/ACN numbers, domain name details, trade mark details or brand name details, etc.), in order to capture/acquire necessary intangible property asset data 12ₙ (and images 12ₙ, etc.) which is/are then cross-checked against trusted intangible property asset data 12ₙ in order to verify particulars of the selected intangible property asset 16ₙ, including, for example, it's availability, history, ownership, authenticity, likely value, etc., which then results in the provision of AI verified and trusted information/data 12ₙ about the selected intangible property asset 16ₙ being returned to the user(s) 20ₙ in a simplified, but detailed, format.

Whilst system 10 and/or method 100 may readily be provided directly to user(s) 20ₙ, as a stand-alone intangible property asset 16ₙ verification system 10 and/or method 100 offering many services/features, such as, for example, those outlined above with reference to the preferred embodiments of the present invention, it is likely that system 10 and/or method 100 of the present invention will be (or will also be) provided as an API to a plurality of third-party service providers, such as, for example, Intellectual Property Offices, Trade Mark Attorneys, marketing professionals, etc., such that those, and any other suitable, third-party service provider(s) is/are able to offer their user(s)/customer(s) 20ₙ trusted verified intangible property asset data 12ₙ unlike any other system/service currently available in the local or global market.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above-described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

1. A method for acquiring, aggregating and analysing asset data from multiple data sources for asset identification, verification and/or information display purposes, the method comprising the steps of:
acquiring initial asset data for a selected asset from a first data source, the initial asset data comprising at least one identifier for the selected asset, and/or one or more word(s) and/or image(s) of the selected asset;
utilising the initial asset data and/or the at least one identifier, to retrieve further predetermined asset data associated with the selected asset from two or more further data sources;
aggregating and analysing the acquired/retrieved initial and further predetermined asset data, whilst also optionally acquiring, aggregating and analysing any further necessary asset data associated with the selected asset from the first and/or two or more further data sources; and
utilising artificial intelligence or machine learning to cross-check or vet the acquired/retrieved asset data in order to verify particulars of the selected asset,
wherein the cross-checked or vetted asset data may then be used for identification, verification and/or information display purposes related to the selected asset.

2. The method as claimed in claim 1, wherein the first data source is a user data source, and wherein the two of more further data sources comprise trusted and non-trusted data sources.

3. The method as claimed in claim 2, wherein the initial asset data for the selected asset comprises at least the at least one identifier, and wherein the initial asset data and/or the further necessary asset data comprises a plurality of images of the selected asset if the selected asset includes multiple dimensions, aspects or forms, and, wherein if the selected asset is a multi-dimensional object or thing, the plurality of images of the selected asset comprises a plurality of images of the selected asset at differing angles.

4. The method as claimed in claim 3, wherein the selected asset is a selected intangible property asset, and wherein the at least one identifier for the selected intangible property asset is at least one of: a word; a letter; a phrase; a number; an image (still or moving); a picture; a logo; a sound; a shape; a two-dimensional shape; a three-dimensional shape; a scent; a movement; a movie/video; a colour; a design; an aspect of packaging; a trade dress; a brand name; a trade mark; a company/business/trade name; a plant variety name; and/or, a combination of any of these aforementioned asset identifiers; and/or, a domain name; a social media, internet or other communications network identifier including a handle or a tag; and/or, an intangible property asset particular(s).

5. The method as claimed in claim 4, wherein the further predetermined asset data, and/or the further necessary asset data, associated with the selected intangible property asset comprises both trusted and non-trusted intangible property asset data, obtained from the two or more trusted and non-trusted data sources, and wherein the trusted and non-trusted intangible property asset data for the selected intangible property asset may include, but is not limited to: government or otherwise officially recorded intangible property asset data; intangible property asset ownership data; associated product and/or service intangible property asset data; and/or, general intangible property asset data available from general data source providers, including search engine and social media service providers.

6. The method as claimed in claim 5, wherein the step of utilising artificial intelligence or machine learning to cross-check or vet the acquired/retrieved intangible property asset data comprises the use of an artificial intelligence algorithm or neural network in association, or combination with, at least object detection technology, in order to verify particulars of the selected intangible property asset.

7. The method as claimed in claim 6, wherein the step of utilising artificial intelligence or machine learning to cross-check or vet the acquired/retrieved intangible property asset data, utilising the artificial intelligence algorithm or neural network in association, or combination with, the at least object detection technology, in order to verify particulars of the selected intangible property asset, includes comparing and contrasting the acquired/retrieved intangible property asset data with the known reliable/trusted data sources in order to differentiate between accurate or false, or fraudulent, intangible property asset data, and/or authentic or non-authentic intangible property assets, and/or related or non-related particulars thereof.

8. The method as claimed in claim 6, wherein the step of utilising artificial intelligence or machine learning to cross-check or vet the acquired/retrieved intangible property asset data, utilising the artificial intelligence algorithm or neural network in association, or combination with, the at least object detection technology, also comprises: interpreting any administrative nuances associated with the acquired/retrieved intangible property asset data; and/or, filtering out any extraneous information/data contained within the acquired/retrieved intangible property asset data.

9. The method as claimed in claim 4, wherein the asset identification, verification and/or information display purposes comprises at least one of the following: selling or purchasing a selected intangible property asset; exploring or researching a selected intangible property asset, and/or features/specifications thereof, including whether or not the selected intangible property asset is available for use, registration and/or protection; recording or modifying a selected intangible property asset security interest; proceeding to register or protect a selected intangible property asset; and/or, proceeding to engage a professional or service provider to assist with further matters associated with a selected intangible property asset.

10. A non-transitory computer readable medium storing a set of instructions that, when executed by a machine, cause the machine to execute a method for acquiring, aggregating and analysing asset data from multiple data sources for asset identification, verification and/or information display purposes, the method comprises the steps of:
acquiring initial asset data for a selected asset from a first data source, the initial asset data comprising at least one identifier for the selected asset, and/or one or more word(s) and/or image(s) of the selected asset;
utilising the initial asset data and/or the at least one identifier, to retrieve further predetermined asset data associated with the selected asset from two or more further data sources;
aggregating and analysing the acquired/retrieved initial and further predetermined asset data, whilst also optionally acquiring, aggregating and analysing any further necessary asset data associated with the selected asset from the first and/or two or more further data sources; and
utilising artificial intelligence or machine learning to cross-check or vet the acquired/retrieved asset data in order to verify particulars of the selected asset,
wherein the cross-checked or vetted asset data may then be used for identification, verification and/or information display purposes related to the selected asset.

11. A system for acquiring, aggregating and analysing asset data from multiple data sources for asset identification, verification and/or information display purposes, the system comprising:
one or modules or applications for acquiring initial asset data for a selected asset from a first data source, the initial asset data comprising at least one identifier for the selected asset, and/or one or more word(s) and/or image(s) of the selected asset;
one or more modules of applications for utilising the initial asset data and/or the at least one identifier, to retrieve further predetermined asset data associated with the selected asset from two or more further data sources;
one or more modules or applications for aggregating and analysing the acquired/retrieved initial and further predetermined asset data, whilst also optionally acquiring, aggregating and analysing any further necessary asset data associated with the selected asset from the first and/or two or more further data sources; and
one or more artificial intelligence or machine learning modules of applications for cross-checking or vetting the acquired/retrieved asset data in order to verify particulars of the selected asset,
wherein the cross-checked or vetted asset data may then be used for identification, verification and/or information display purposes related to the selected asset.

12. The method as claimed in claim 7, wherein the step of utilising artificial intelligence or machine learning to cross-check or vet the acquired/retrieved intangible property asset data, utilising the artificial intelligence algorithm or neural network in association, or combination with, the at least object detection technology, also comprises: interpreting any administrative nuances associated with the acquired/retrieved intangible property asset data; and/or, filtering out any extraneous information/data contained within the acquired/retrieved intangible property asset data.

13. The method as claimed in claim 5, wherein the asset identification, verification and/or information display purposes comprises at least one of the following: selling or purchasing a selected intangible property asset; exploring or researching a selected intangible property asset, and/or features/specifications thereof, including whether or not the selected intangible property asset is available for use, registration and/or protection; recording or modifying a selected intangible property asset security interest; proceeding to register or protect a selected intangible property asset; and/or, proceeding to engage a professional or service provider to assist with further matters associated with a selected intangible property asset.

14. The method as claimed in claim 6, wherein the asset identification, verification and/or information display purposes comprises at least one of the following: selling or purchasing a selected intangible property asset; exploring or researching a selected intangible property asset, and/or features/specifications thereof, including whether or not the selected intangible property asset is available for use, registration and/or protection; recording or modifying a selected intangible property asset security interest; proceeding to register or protect a selected intangible property asset; and/or, proceeding to engage a professional or service provider to assist with further matters associated with a selected intangible property asset.

15. The method as claimed in claim 7, wherein the asset identification, verification and/or information display purposes comprises at least one of the following: selling or purchasing a selected intangible property asset; exploring or researching a selected intangible property asset, and/or features/specifications thereof, including whether or not the selected intangible property asset is available for use, registration and/or protection; recording or modifying a selected intangible property asset security interest; proceeding to register or protect a selected intangible property asset; and/or, proceeding to engage a professional or service provider to assist with further matters associated with a selected intangible property asset.

16. The method as claimed in claim 8, wherein the asset identification, verification and/or information display purposes comprises at least one of the following: selling or purchasing a selected intangible property asset; exploring or researching a selected intangible property asset, and/or features/specifications thereof, including whether or not the selected intangible property asset is available for use, registration and/or protection; recording or modifying a selected intangible property asset security interest; proceeding to register or protect a selected intangible property asset; and/or, proceeding to engage a professional or service provider to assist with further matters associated with a selected intangible property asset.
